(19) United States
(12) Patent Application Publication
(10) Pub. No.: US 2005/0275942 A1
(43) Pub. Date: Dec. 15, 2005

(54) Method and apparatus to retrofit a display device for autostereoscopic display of interactive computer graphics

(76) Inventors: David Hartkop, Central Point, OR (US); Jason Dunn, Playa Del Ray, CA (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 11/131,717

(22) Filed: May 18, 2005

Related U.S. Application Data
(63) Continuation-in-part of application No. 10/817,592, filed on Apr. 2, 2004.

(51) Int. Cl. G02B 27/22

(52) U.S. Cl. 359/464

(57) ABSTRACT

A device and method for retrofitting a 2D display monitor to provide 3D stereoscopic displays is provided. The device includes a shutter plate that is releasably connectable to the front of 2D display monitor, and an interface device connects the shutter plate to the computer driving the display. Through the use of time-multiplexed techniques, the shutter plate of the present invention provides true 3D stereoscopic displays from 2D display devices.

### CROSS REFERENCE TO RELATED APPLICATIONS

This application is a Continuation-in-Part of co-pending U.S. patent application Ser. No. 10/817,592 filed Apr. 2, 2004.

### BACKGROUND OF THE INVENTION

1. Field of the Invention

The present invention relates to three dimensional (3D) image reproduction, and more particularly, it relates to a method and apparatus for displaying stereoscopic images on standard computer or other display monitors.

2. Description of the Prior Art

Various approaches to 3D image reproduction have been experimented with and implemented in different aspects of industrial life. Many of today's current imaging applications are requiring of more detail and the ability to “look around” or see all sides of an image in true 3D representation. Some exemplary applications for such imaging include Medical, Military and other industrial and recreational fields.

Among the first generation of 3D image reproduction is the Stereoscope. Stereoscopes were first invented in 1833 by Sir Charles Wheatstone and were designed to produce a three dimensional image that one could see through a special viewer. It requires a special camera that takes two photographs at slightly offset angles. When viewed through the stereoscope, each eye is presented with a slightly different image that would create a three dimensional effect.

Stereoscope technology is one of the most widely available technologies, showing up in 3D movies, virtual reality, simulation, etc. Stereoscopes require special headsets or glasses in order to view properly, and have a fixed perspective that does not change for position.

Examples of these technologies include: Anaglyph—which uses a pair of red and blue color glasses. The stereoscopic effect is achieved easily with any kind of display that includes LCD, and Projectors; Polarizing Filter method—By using a pair of polarizing glasses, stereoscopic images are also easily seen without losing colors. However, ordinary computer displays cannot be used for such applications and therefore require the use of a projection type display for this method. To realize the stereoscopic effect, a polarizing screen designed for the projector must be attached in front of the lens; Synchronizing Shutter—By using a pair of synchronizing shutter glasses, you can see the stereoscopic effect by using any computer display. Synchronizing shutter glasses are a little more expensive than others and the viewed image becomes a little darker. A major limitation of stereoscope technique is that it produces a single fixed perspective regardless of viewing angle and as such, are not true holograms.

Another later version of the Stereoscope is the Auto-stereoscope, which was designed to negate the need for specialized eyewear by the user in order to view the 3D images.

Variations in the Auto-Stereoscopes include:

A Lenticular screen uses a ridged screen to separate two different images so that either eye sees the one designated for it. The lenticular screen is commonly seen in novelty gifts, baseball cards and advertising displays. They can also utilize projectors in which the binary images are projected onto a screen, but the same limitations apply. Drawbacks include cost of manufacture, low quality of the image, significant tearing (broken or misplaced image elements), limited field or view and fixed perspective. The Lenticular screen is not a true hologram.

Holographic Optical Elements (HOE) uses striped horizontal HOE's and a distant light source to create a three dimensional effect. This is an emerging technology that creates a stereoscopic image for the viewer. However, HOE has a limited field of view that can be mechanically shifted by moving the light source in conjunction with a head mounted positioning system. Thus, HOE has a fixed perspective and is therefore not a true hologram;

The Grid barrier screen method also allows the viewer to see the stereoscopic images with naked eyes. The principle of this method is similar to that of the lenticular screen method as it applies the optical effect of a pinhole in place of a lens. However, the barriers cover a part of image lines, so the stereoscopic image becomes darker than the lenticular screen method;

The Prism screen is similar to a lenticular screen, however, prisms overlay a liquid crystal display (LCD) screen as opposed to being projected upon it. Thus, prism screens have a fixed display angle, as well as fixed perspective; and

Curved screen projection—uses a lensatic image warp and curved screen to create the illusion of an immersive 3 dimensional environment. This is used for simulators for training. It does not achieve a true, three-dimensional holographic effect.

Other 3D image reproduction technology includes Holography. Holography was initially created in the 1940's using mercury arc lamps, these took off in the 1960's with the development and application of lasers. The holographic image generated results from the quantum interference between a laser shined on stationary object and a reference beam. The interference is recorded in a film like medium such that, when viewed, recreates the light patterns of the original object, showing a three dimensional image.

Variations in Holograph Technology include:

Voxels—which create a hologram by compositing multiple slices of 2D medical imagery onto a single piece of holographic film. This is slow and cumbersome process;

Real Time Holography—this is an emergent technology that uses configurable lasers to recreate the holographic image floating in space. Roadblocks include the vast amount of information necessary, the complete lack of color, and the difficulties of dealing with and replicating quantum interactions;

Volumetric display—creates a static or active volume in which 3 dimensional images can be displayed. Light is painted on either a rapidly rotating ‘canvas’ (active), or in a liquid or solid dispersion medium (static). These displays disallow interaction with the hologram, limiting the effectiveness and commercial nature of the process;

Micro mirror projection—uses an array of independently mobile micro-mirrors and lasers to recreate the interactions of a light in a holographic image. Micro mirror projection is able to create full motion holograms but at the price of limited resolution and color scale; and,

Mirror boxes—use mirrors to ‘project’ the 3D image of a physical object contained therein outside of the box. This is an illusion and a parlor trick, without any real commercial merit except as a curiosity.

### SUMMARY OF THE INVENTION

According to one aspect of the invention, the apparatus for retrofitting a 2D display monitor used with a computer for auto stereoscopic display includes a shutter plate positioned in front of and releasably attached to the display monitor, and an interface device connected to the display monitor, computer and the shutter plate, said shutter plate and said interface device operatively provide stereoscopic display to a user of the 2D display device.

A connection system enables the shutter plate to be releasably attached to the front of the 2D display monitor. An alignment system, potentially integrated into an outer frame of the shutter plate, enables the user to align the view for stereoscopic display of graphic data.

According to another aspect of the invention, method for retrofitting a 2D display monitor for 3D stereoscopic display of images includes the steps of providing and connecting a shutter plate to the front of the 2D display monitor, providing and connecting the computer, the 2D display and the shutter plate to an interface device, and controlling the interface device to cyclically control the shutter plate to selectively cycle through optically active columns in the shutter plate in response to graphic information supplied to the interface device via the computer.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a block diagram of the scanning aperture holographic display system according to an embodiment of the invention;

FIG. 2 is a plan view of the geometric relations of 3D display system according to an embodiment of the invention;

FIG. 3 is a plan view demonstrating the angular resolution considerations for the 3D display system according to an embodiment of the invention;

FIG. 4 is a plan view demonstrating the angular resolution considerations for the 3D display system according to an embodiment of the invention;

FIGS. 5 and 6 demonstrate aperture view equivalence according to an embodiment of the invention;

FIGS. 7 and 8 demonstrate persistence of vision according to an embodiment of the invention;

FIGS. 9a, 9b and 9c shows variations in the visual constraints of virtual images traced through aperture to real image;

FIG. 10 is block diagram of the basic construction of the scanning aperture holographic display system according to an embodiment of the invention;

FIG. 11 is block diagram of the basic construction of the scanning aperture holographic display system according to another embodiment of the invention;

FIG. 12 is block diagram of the basic construction of the scanning aperture holographic display system according to yet another embodiment of the invention;

FIG. 13 is block diagram of the basic construction of the scanning aperture holographic display system according to a further embodiment of the invention;

FIG. 14 is block diagram of the basic construction of the scanning aperture holographic display system according to yet a further embodiment of the invention; and

FIG. 15 is plan view of an aperture plate having a 24×18 resolution with discreet horizontal and vertical viewing angles for use with a 2-axis scanning aperture 3D display system according to an embodiment of the invention;

FIG. 16 is a top view graphical representation of the intersection of maximal angle projections from the most distant apertures in a 2 axis system according to an embodiment of the invention;

FIG. 17 is a side view graphical representation of the intersection of maximal angle projections from the most distant apertures in the vertical direction;

FIG. 18 is graphical view of the uncompromised viewing volume from behind the 3D display according to an embodiment of the invention;

FIG. 19 is a graphical view of the uncompromised viewing volume from in front of the 3D display according to an embodiment of the invention;

FIG. 20 is a schematic representation of a solid state 3D display system according to an embodiment of the invention;

FIG. 21 is a schematic representation of another solid state 3D display system according to another embodiment of the invention;

FIG. 22 is a schematic representation of another solid state 3D display system according to another embodiment of the invention;

FIG. 23 is a graphic representation of the maximum viewing angle for a given substrate according to an embodiment of the invention;

FIG. 24a is a system block diagram showing the relationship between the components of a display system implementing the aspects of the invention;

FIG. 24b is an alternative system block diagram, showing the relationship between the components of a display system implementing the aspects of the invention;

FIG. 25 is a schematic view of the mounting arrangement of the shutter plate according to an embodiment of the invention;

FIG. 26 shows a monitor specific adapter frame according to an embodiment of the invention;

FIGS. 27a and 27b is a schematic representation of two operational states of multiple vertical columns of liquid crystal regions that make up the shutter plate according to an embodiment of the invention;

FIG. 28 is a plan view of the basic structure of the shutter plate according to an embodiment of the invention;

FIG. 29a shows a top view of an alignment light system according to an embodiment of the invention;

FIG. 29b shows an enlarged front view of the alignment light system according to an embodiment of the invention;

FIG. 29c shows a cross sectional view of the alignment light system according to an embodiment of the invention;

FIG. 30 shows a plan view of the basic structure of the shutter plate with alignment system according to an embodiment of the invention.

FIG. 31 shows one method of attaching the aperture plate to a display monitor according to a preferred embodiment of the invention;

FIGS. 32A-E share various other methods of attaching the aperture display plate to a display monitor according to preferred embodiments of the invention;

FIG. 32F shows a method for aligning, using a universal stepped adapter or an integrated step pattern in the frame of the liquid crystal panel; and

FIGS. 33-37 show another method for seating the liquid crystal panel (aperture display plate) against the frame of a CRT, LCD, OLED, small DLP rear projection, or otherwise flat panel monitor by means of small removable corner blocks, according to an embodiment of the invention.

FIGS. 38A-B show a graphical representation of two sets of geometric considerations that apply when designing a given embodiment of the invention;

### DETAILED DESCRIPTION OF PREFERRED EMBODIMENTS

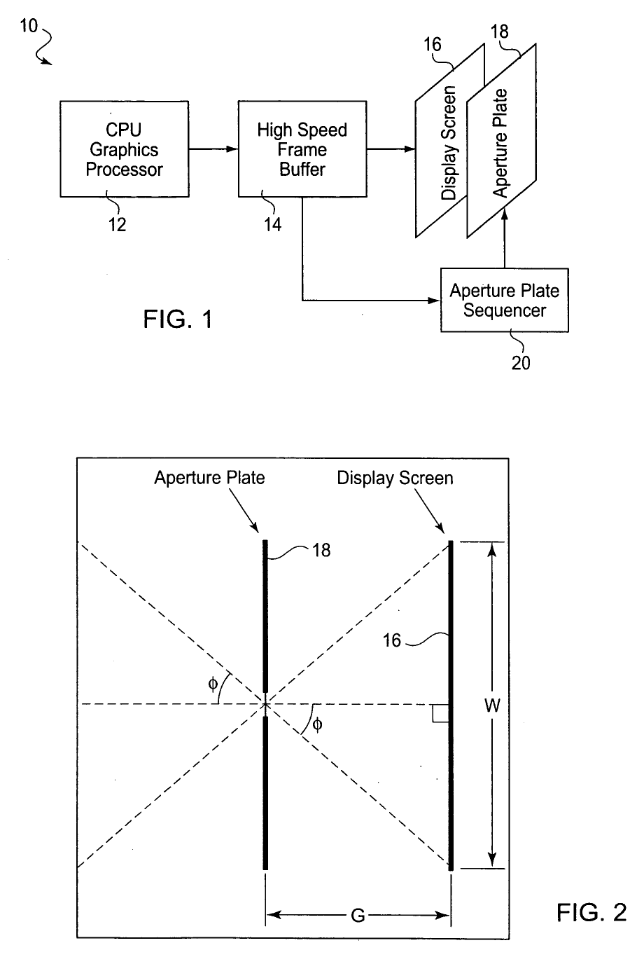

Referring to the block diagram of FIG. 1, there is shown a general depiction of the scanning aperture three dimensional display system 10 according to an embodiment of the invention. In a basic form, the system includes a central processing unit/graphic processor 12, a high speed frame buffer 14, a display screen 16, an aperture plate 18 and an aperture plate sequencer 20.

The embodiment of FIG. 1 is a solid state example of the invention, having no moving parts. In accordance with various embodiments, described herein, the display screen 16, aperture plate 18, aperture plate sequencer 20 and other hardware/software components can be implemented in many different ways without departing from the spirit of the invention. In accordance with other embodiments, the apertures in the aperture plate 18 can be of different configuration. These embodiments are discussed in detail below, however a brief explanation of the operating principles and considerations in the implementation of the scanning aperture 3 dimensional (3D) image display system of the present invention are explained first.

Images produced by means of the scanning aperture display of the present invention can be termed holograms in the broader conceptual definition. As described earlier, standard holography is based on optical interference to produce unique light patterns for a given viewing angle. In contrast, the scanning aperture display relies on the viewer's parallax angle and human persistence of vision.

The fundamental basis for the reconstruction of three-dimensional images using the scanned aperture technique is a property termed herein as aperture-view equivalence (AVE). Aperture-view equivalence (AVE) describes an aperture as being a window through which only one dimension (a single ray of light at a specific angle to the normal) may be viewed by a viewer at a particular angle to that aperture. The viewer's angle of view is considered to be at a fixed distance from the small aperture, and to rotate in longitude and latitude about a point fixed in the center of the aperture. Thus, it becomes clear that total viewable light pattern transmitted through a single aperture can be described by just two dimensions: a rotation (or translation) along a vertical axis, and a rotation (or translation) along a horizontal axis. In essence, any light source, be it three or two-dimensional will be transmitted through an aperture in just two dimensions. In this way, the views of a three-dimensional object or a two dimensional projection through an aperture can be quantitatively equivalent.

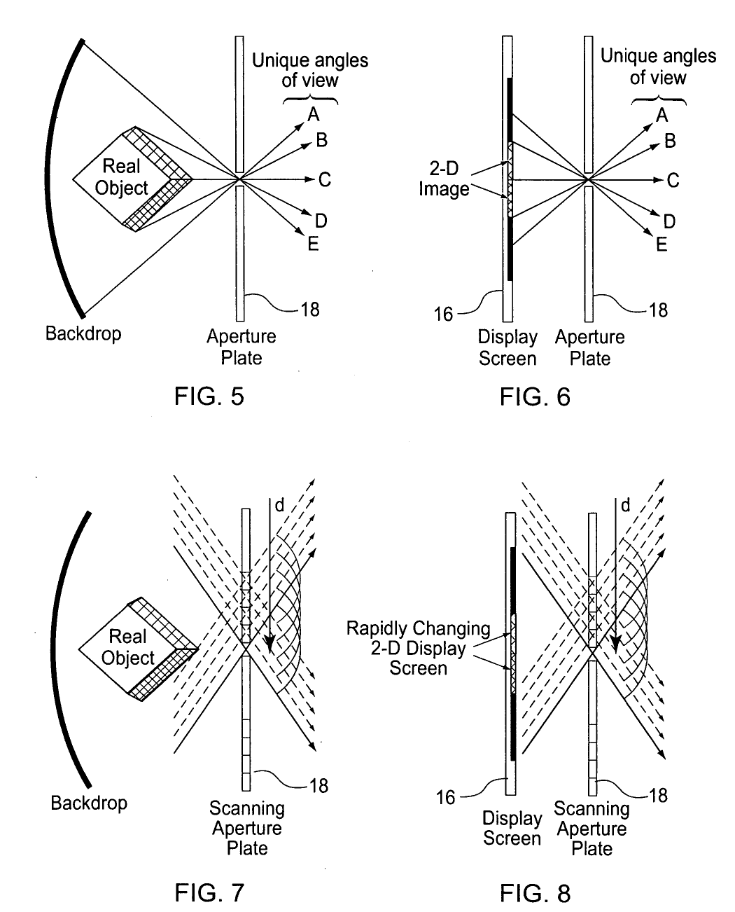

FIGS. 5 and 6 demonstrate AVE. In FIG. 5, a real object, in this case a cube, floats before a black backdrop. The cube is viewed through the aperture and can be seen from anywhere between angles B and D. Angles A and E provide only a view of the backdrop. FIG. 6 utilizes a flat display screen 16 in place of the real object. It is noteworthy, however, that the views through the aperture from angles A through E are identical to those in FIG. 5.

Image Construction through Persistence of Vision

Due to AVE, it is possible to mimic the appearance of a three-dimensional object with a two-dimensional view screen, provided that the field of view is projected through a single visual point (i.e., an aperture). What remains is a method for constructing a continuous image field made up of many such individual apertures. It is not spatially practical to simply place apertures side-by-side, as there is a required distance that must be maintained between each in order to afford sufficient non-overlapping viewing angles with respect to the 2-D display screen behind. Such a screen would either appear as a series of discreet dots against a black background, or would make a trade off in angular resolution in order to place apertures closer together. The preferred method to preserve both angular resolution and resolution of the display field under this paradigm is to dramatically increase the resolution of the 2-D display screen. This, for many practical reasons, is not a desirable solution. An alternative to the use of static apertures as discussed above is the use of scanning, or dynamic apertures. Such apertures are made to change location in the display field with respect to time, and, because of human ‘persistence of vision’ can be used to construct a fully-filled display field.

For the purpose of this discussion, “Persistence of Vision” (POV) is defined as a property of human vision that causes it to interpret many brief visual states as a single or continuous perceived visual state. For example, a row of sequentially flashing lights will appear to glow simultaneously if the flash rate of each light is substantially high enough. As a simplified example, a single blinking light will appear to glow continuously if its rate of blinking is fast enough. For a general benchmark, a light blinking at or above roughly 20 Hz will appear to glow continuously. This property of vision has also been found to apply to the viewing of light transmitted through shuttered or moving apertures. This suggests a new method for filling a display field with only light transmitted through apertures. If each aperture exists in at a location in the display field for only a brief period of time, the open apertures in the display field will be made to exist at a new location, shifted spatially by the width or height of one aperture. This sequencing of aperture position continues until all points of the display field have been occupied by an open aperture for a brief period of time. The sequence then resets. Assuming the entire sequence can be performed at or above 40 Hz, that is, within the time of 1/40^{th} of a second, the translation of individual aperture positions will not be apparent.

FIG. 7 demonstrates how an aperture may be scanned across a viewer's visual field to provide a more complete view of the cube for the viewer. The rapidly moving aperture, in this case a slit, does not appear as a single moving band of view. Instead, because of ‘persistence of vision,’ the entire scanning-aperture plate appears to become transparent for a moment. If the scanning is rapidly repeated, the plate will remain transparent to the viewer.

The viewer will have an accurate three-dimensional view through the image plate at a truly three-dimensional object. FIG. 8 shows how an identical aperture may be scanned before a two-dimensional display device 16 in order to ‘blend together’ the positions of individual apertures, similarly constructing an entire display field. In order to reconstruct a truly three-dimensional image, however, the display screen 16 must represent an accurate two-dimensional projection with respect to the given aperture position. For this reason, every change in aperture position (d) requires a change in the 2-D image displayed. To clarify, the perspective from each different viewing angle to be made available requires the display of a separate 2-D image behind each momentarily open aperture. Apertures are sequenced in a cyclic manner, the period of each cycle being less than the persistence of vision threshold of human sight. With these conditions met, the view of a virtual object through such a display will appear equivalent to that of a real object in three-dimensional space.

FIG. 2 shows the geometric relationship between the display system's Maximum Viewing Angle (given as Φ in degrees), the Gap (given as G, in meters), and the Aperture Projection Width (given as W, in meters). The Aperture Projection Width W is the width of a region of image on the display screen directly behind the aperture, having a width equal to the width of the aperture multiplied by the number of discrete viewing angles. It is intended to be viewed over a specific range of angles through the aperture, and so is centered directly behind the given aperture. The Maximum Viewing Angle Φ defines the maximum angle (away from the normal projection through the aperture) at which light originating from within the Aperture Projection Width is still visible through the aperture. The Gap G is defined as the distance measured from the plane of the optically active region of the aperture plate 18 to the light-emitting surface of the video display screen 16. Gap G can be any distance, but most commercially acceptable embodiments will have a gap in a range of 0.1 cm -5 cm, according to various embodiments of the invention. The mathematical relationship between these elements in proper configuration is given as follows:

$$tan ( Φ ) = \frac{W}{2 G}$$

The value of W can be described as the product of the aperture width (given as P, in meters) and the total number of discreet viewable angles to be constructed by the display (given as A.)
W=PA
By substitution, the length of G and the Maximum Viewing Angle of the display relate to A and P as given:

$$tan ( Φ ) = \frac{PA}{2 G} = \frac{W}{2 G}$$

For a given implementation, the value of P (i.e., the aperture width), is also equal to (or slightly larger than the pixel width. Because the width of the aperture is close to the width of a pixel on the display screen, the resolution of the 3D image will approach or match the resolution of the display screen.

The key to the effect of constructing true 3-dimensional images is the ability to produce a variety of discreet viewing angles, which radiate away from any particular point on the screen. In effect, each point on the display screen can be observed to have several different values of brightness and color, depending on the viewer's perspective. A single axis system (meaning only horizontal parallax) has discreet viewable angles viewed through vertical slit-type aperture. The single axis system may be viewed by moving horizontally while observing the screen. A two-axis system (having both horizontal and vertical parallax, described in later embodiments) has discreet viewable angles viewed through different type apertures (e.g., pinholes, etc.). The two axis system may be viewed by moving horizontally as well as vertically while observing the screen.

During operation of a scanning aperture display, the number of discreet viewable angles A will most likely be less than the display screen's total pixel-count along the axis in consideration. (Pixel count for an axis, or resolution R). In order to maximize light output of the display, multiple apertures can be used at once. Optimally, an open aperture will be located every A'th aperture over R pixels. The following equation describes the relationship between A, R, and the total number of open apertures for a given moment (given as whole number a.):

$$a = \frac{R}{A}$$

This equation assumes that R is a whole number multiple of A. It is not necessary for this to be true, but it is somewhat convenient when designing a system.
Frame Rate and Aperture Response Time

During operation, the elements of the aperture plate must rapidly change states in sequence, transitioning momentarily from opaque to transparent and back. This succession of rapid state transitions emulates a moving or scanning aperture, either a pinhole, a slit or other aperture configuration depending on the aperture type. For each transparent ‘aperture’ configuration, a different video image is displayed on the display screen behind. The frame rate r (frames per second) of the required display screen is described in terms of viewable angles A:
r=(refresh rate?) (A)
This relationship acknowledges the fact that, in order to visually blend or composite the sequencing of open aperture positions, a complete scan cycle must be accomplished at a refresh rate sufficiently fast enough that the human eye will not detect the scanning effect. It is generally accepted that a refresh rate of approximately 40 times per second is sufficient. This cycle rate must be maintained regardless of the total value of A.

Given that a large number of discreet angles is desirable and that total sequential-cycle frequency of these angles must remain at or above 40 Hz, the optical response time for a given shutter is somewhat demanding. The maximum acceptable Aperture Optical Response Time T (in seconds) is as follows:

$$T = \frac{1}{2 ( r )}$$

Faster response times enable higher contrast ratios, reducing frame to frame cross talk, which produces undesirable fogging or smearing of the image. Those of ordinary skill will recognize that suitable images can be produced with optical response times nearly twice as long as described in the equation above, but best results are gained with faster response.
Consideration for Angular Resolution

When designing an implementation of scanning aperture holographic display technology of the present invention, an important concept to understand and utilize properly is that of Angular Resolution. The Angular Resolution (AR) for a given display refers to the total number of discreet angles encountered per unit length along the observer plane, at a particular observer distance.

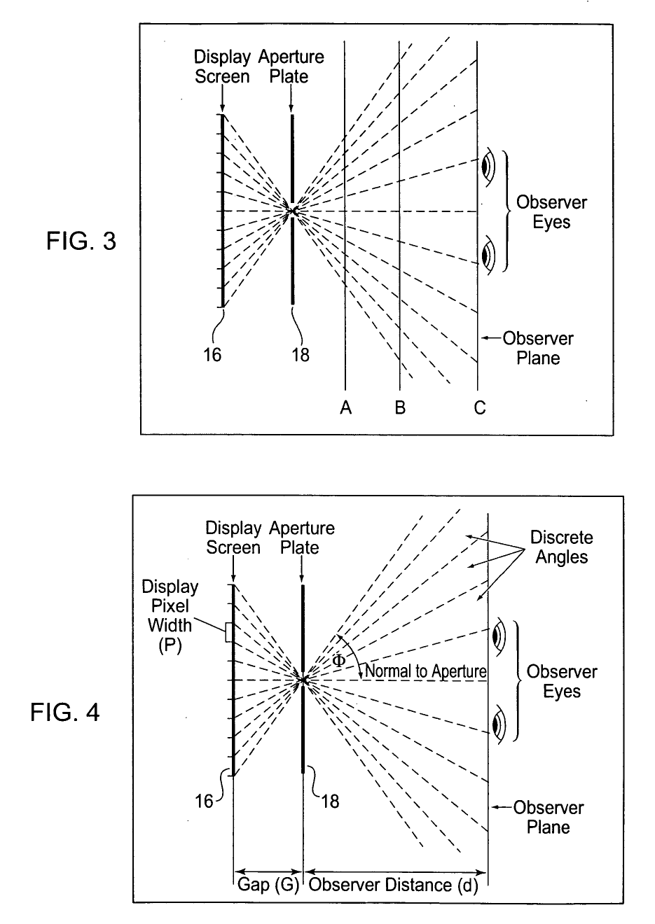

Referring to FIG. 3, discreet angles (separated in the Figure by dashed lines) radiate away from the aperture toward the observer's eyes. The observer's eyes are considered to be directly on the observer plane, which is parallel to the aperture plate. Notice the intersection of the discreet angles with observer planes at different distances, A, B, and C from the aperture plate 18; the total number of discreet angles per unit length of the observer plane decreases as the distance from the aperture plate 18 increases. It is also interesting to note that the observer eyes at the observer plane C encounter different discreet angles, and can thus perceive stereoscopic parallax (See FIG. 4). By shifting the head left or right (along a horizontal axis), the eyes will encounter new and different discreet angles, maintaining an adaptive and accurate parallax over a range of angles. Should the observer move too far from the aperture plate, or there simply be too few discreet angles, both eyes will fall within the same discreet angle. When this occurs, the observer experiences stereoscopic breakdown, at which point the image becomes a simple 2-D rendering. For this reason, it is important to configure the scanning aperture 3D holographic display system of the present invention to maximize angular resolution for a given range of observer plane distances.

The Minimum Angular Resolution at which stereoscopic separation is maintained can be calculated as a ratio between the minimum number of required angles for stereoscopic view (i.e., 2 angles), and the average separation between human eyes, accepted to be approximately 65 mm. Thus, the angular resolution was found to be close to 31, given in discreet angles per meter:
(2 discreet angles)/(65 mm between observer eyes)=31 discreet angles/meter
This is the absolute minimum required for the observation of a 3-dimensional image over the full range of display angles. With a display set to this minimum, however, an image can be seen to ‘jump’ or ‘slip’ slightly when the viewer's eyes transition from one set of discreet angles to another. Much better results can be achieved by doubling or quadrupling the angular resolution encountered at a given observation distance from the aperture plane.
Consideration for Virtual Images at Different Depths, Regarding Angular Resolution:

The desired Virtual Display Depth Range should also be taken into account when structuring the angular resolution pattern for a scanning aperture display implementation. Virtual objects set in intersection or near the aperture plane make the most efficient use of angular resolution, and are least likely to encounter stereoscopic breakdown. Stereoscopic breakdown is most likely to occur in two broad situations: 1) The observer is near the screen and a virtual object is constructed to appear ‘deep’ behind the aperture plane; and 2) The observer is at a distance from the screen and a virtual object is constructed to ‘protrude’ a significant distance from the aperture plane.

The most successful remedy in both cases is to design for an increased angular resolution over the desired viewing range. It should be noted that the simplest way to increase angular resolution is to decrease the maximum viewing angle of the display. Notice in FIG. 3 that the angular resolution over the entire viewing range at a radial distance from the aperture is greatest near the extremes in viewing angle, and least in the middle. For displays with extremely wide viewing angles, this effect makes it inefficient to increase the angular resolution, as most of the increase occurs at the extremes of the viewing range.

Calculating Angular Resolution

Provided below is one useful method for determining the minimum angular resolution experienced by an observer moving through the entire viewing range at a fixed radial distance from a given aperture.

The Angular Resolution Measured Minimum (ARmin) can be found at a viewing angle normal to the aperture (See FIG. 4).

$$AR min = \frac{G}{dP}$$

The ARmin is useful when designing a system because it allows engineers to quickly identify angular resolution deficiency (being AR's less than 31 discreet angles per meter). It can not, however, be used to determine the angular resolution of a display at the extreme ends of its viewing range
Visual Constraints with Scanning Aperture Hologram Displays

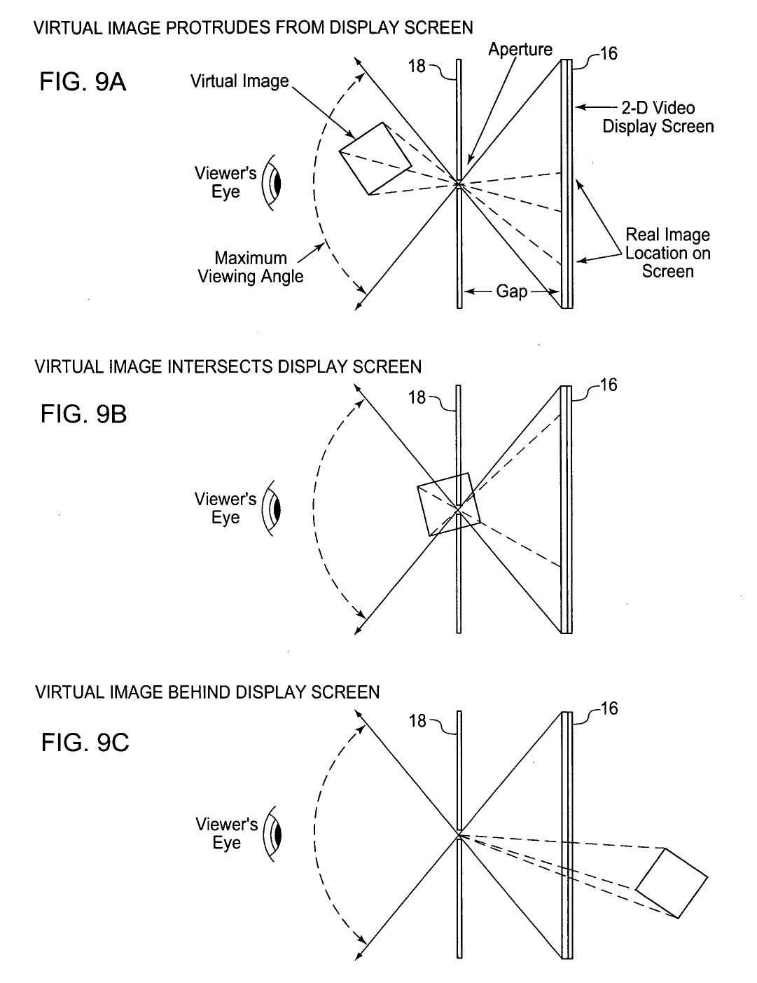

Objects displayed through a scanning aperture display device may be viewed over a wide range of angles by simply changing viewpoints by repositioning the head (eyes) in the real world. Objects presented on the screen can be mapped in such a way as to appear behind the plane of the screen, in intersection of the plane, as well as in front of the plane. (See FIGS. 9a-9c) The image is constrained in that plane of the screen fully defines the area in which the image may be formed. In other words, images seen on the screen may be seen to extend both behind and in front of the screen's surface, but no image can be formed outside the screen's edges.

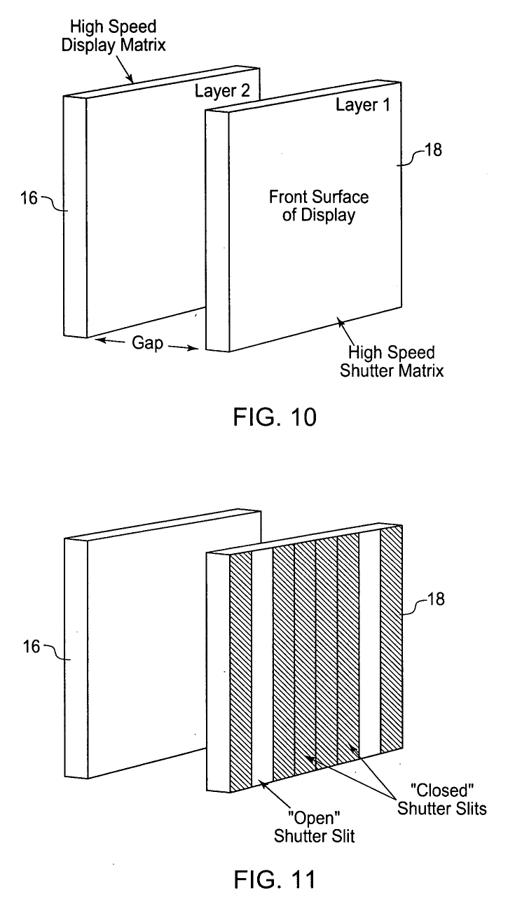

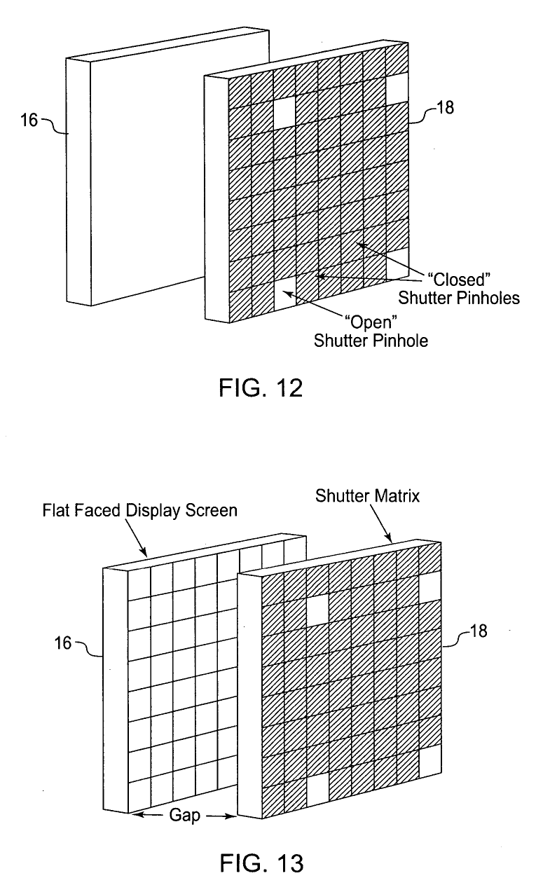

FIG. 10 shows as basic representation of the scanning aperture 3D image display system according to an embodiment of the invention. As shown, the system includes of a matrix of high speed shuttered apertures (Layer 1), i.e., aperture plate 18, a gap G of a specific length, and a high speed video display matrix (Layer 2), i.e., display 16. In one embodiment, the aperture plate 18 is a high-speed optical shuttering system, employing high-speed liquid crystal or other birefringant optical shuttering technology. Its ‘shutters’ are numerous and are arranged as either narrow vertical columns (See FIG. 11) or as a matrix of fine rectangular windows (See FIG. 12).

As discussed above, a precisely maintained gap G separates the aperture plate 18 and the display 16. The gap G is preferably greater than the width of one ‘shutter’ and less than the entire width of the first aperture plate 18. Most preferably, the gap G will be in a range of 0.1 cm to 5 cm, according to various embodiments of the invention.

The display 16 is preferably a high frame-rate video display device, and may employ any of a variety of display technologies. Examples of these technologies would be: High-speed liquid crystal display technology or Ferroelectric liquid crystal display (FLCD); Organic LED technology; Miniature LED technology, plasma, zero twist nematic LC; rear projection using multiple projectors or a DLP mirror chip (described below); or a hybrid projection system based on the combination of any of these technologies. Preferably, the pixels on the display screen are not wider than the width of any single ‘shutter’ on the aperture plate 18.

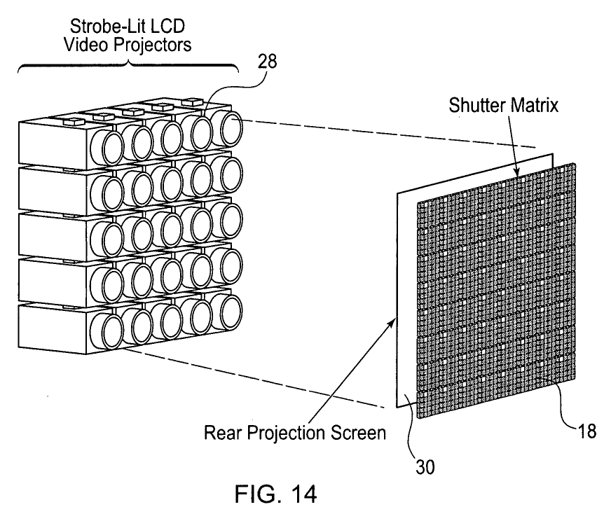

FIG. 13 shows a flat faced display screen that can be implemented using any one of the plasma, FLCD, LED, OLED or LCD display technology. FIG. 14 shows a rear projection hybrid system using multiple LCD video projectors back lit by sequenced strobe lights being used as an alternative to a single high-speed display screen 16.

According to one preferred embodiment, the display screen 16 is capable of producing a sustained display frame rate between 150 and 10,000 frames per second. A suitable example of such high speed video display screen used for the proposed purpose of parallax reconstruction in the 3D display system of the invention will use a Smectic C-Phase Ferroelectric Liquid Crystal as its electro-optic medium.

In accordance with one aspect of the invention, the scanning aperture 3D display device receives its input from a digital image source, such as a computer, disk array, or a solid-state data buffer. The device is electronically driven by specialized, self-contained driver circuitry. The driver circuitry is capable of formatting a 3D data input for holographic viewing in real time. Input file types may include common 3D codecs such as DXF, STL, LWO, XGL, and VRML. Input sources will vary according to application. Applications include medical, industrial, commercial, scientific, educational, and entertainment related viewing systems.

Two-Axis System

A two-axis 3-D display system differs structurally from the aforementioned one axis system most noticeably in the shape of the parallax barrier active regions, here forward referred to as apertures. Each aperture is a transparent region of the ‘aperture plate’, which rapidly translates across the face of the aperture plate. In the one-axis system, the aperture is preferably vertical ‘slit’ with a width matching the width of pixels of the display screen, and a height running the entire height of the aperture plate. In a two-axis system, aperture dimensions will ideally match the respective dimensions of each pixel of the display screen. Further, the total number of active regions on the aperture plate will be less than or equal to the total number of pixels on the display screen.

Eliminating Frame Vignetting

Most commonly, the aperture plate and display screen sizes will be equal, but it may be desirable for some applications to extend the display screen's edges beyond the edges of the aperture plate, both horizontally and vertically. The effect will be to eliminate the otherwise inherent ‘inset frame’ effect seen around the edge of the one or two axis systems. This effect will cause a dark vignette to form at the edges of the screen when looking into the screen from off-normal angles. The apparent thickness of this vignette approaches the width of the gap G between the aperture plate and the display screen. For high-resolution displays of fewer than 100 discreet angles, the effect will be minimal. The effect will, however, become more noticeable if a large number of discreet angles is called for, or should a narrower maximum viewing angle be desired. (Both these conditions contribute to a widening of the gap between the aperture plate and display screen, and hence a thickening of the outer frame. Should one choose to eliminate the ‘inset frame’ effect, one should make the display screen wider than the aperture plate by a number of pixels equal to the total number of discreet horizontal angles to be presented, and taller than the aperture by a number of pixels equal to the total number of discreet vertical angles to be presented. The size-increased display screen is then centered behind of the aperture plate, at the appropriate gap distance. If this technique is applied to a single axis system, the width of the display screen should be increased by a number of pixels equal to the total number of discreet angles, and the height may be increased by the same number of pixels. The display preferably will be centered behind the aperture plate.

Frame Rate, Discreet Angle Allocation, Compromised Views

Two axis systems require substantially more discreet viewing angles than single axis displays. The total number of discreet angles (A) required is equal to the product of the number of desired horizontal angles (h) and the number of desired vertical angles (v).
A=hv

The required display frame rate is given as the product of the total number of discreet angles (A) by the minimum fps required to overcome visible flickering (generally between 20 and 30)
r=20A

The 2-axis implementation may have a different number of vertical angles than horizontal angles. This is advantageous because, for an upright display screen, most user motion and depth perception occurs in the horizontal direction. The number of vertical angles should, however, be a reasonably large fraction of the total number of angles. For example, to place 100 angles along the horizontal axis and only 12 on the vertical axis requires 1,200 discreet angles, running at a frame rate of 24,000 fps. This is a very high frame rate, requiring an aperture optical response time of 40 microseconds at the longest. Also, the imbalance between the number of horizontal and vertical angles will be reflected by a very narrow maximum vertical viewing angle. This restricts the viewing volume in which a viewer's eyes must exist in order to perceive an uncompromised 3-D view. According to an aspect of the invention, the frame rate of the display device can be in a range 160-10,000 fps.

A compromised view of the display is any view from which the viewer's angle of view to some portion of the screen exceeds that portion of the screen's maximum viewing angle. When using an air-gap separation between the aperture plate and the display screen, a compromised view will resemble a fractured or repeated portion of the current image in all regions seen from an excessive viewing angle. When viewing images on a display having a solid-substrate type gap, a region viewed from too excessive an angle will appear to stretch slightly, beyond which the region will appear as a solid color. This is due to an internal refraction effect, which prevents the transmission of light from angles outside the refractive maximum of the substrate.

Scanning Patterns

Apertures in a two-axis system will be cycled through the total number of discreet viewing angles afforded by the display. To maximize the brightness of the image, it is desirable to have as many apertures open on the screen at a given time as possible. This number is found by dividing the total number of aperture plate pixels by the total number of discreet angles. More specifically, one can find the total number of vertical columns of open apertures by dividing the total number of horizontal apertures in the aperture plate by the chosen number of discreet horizontal angles. In the same way, the total number of horizontal rows of open apertures is found by dividing the total number of vertical apertures in the aperture plate by the chosen number of discreet vertical angles. If the chosen number of apertures are opened in vertical columns and horizontal rows, and distributed evenly, the result will be a grid of ‘dots’ or open apertures in the aperture plate. In one embodiment, each open aperture can be thought of as defining one corner of a rectangular region of scan.

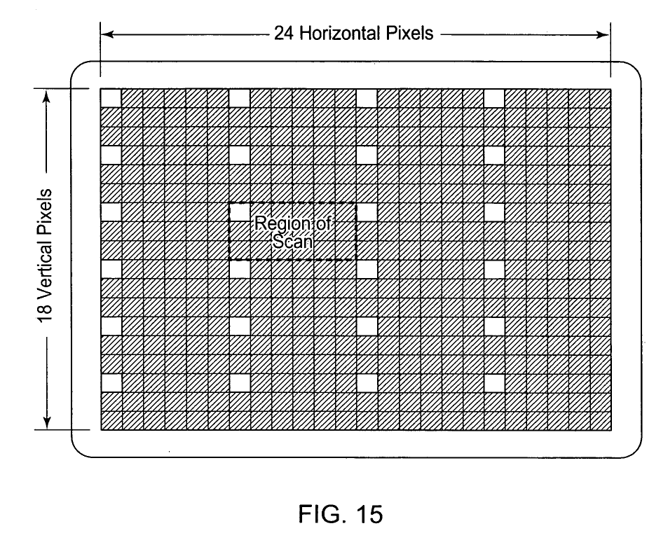

In operation, the aperture plate will translate these open apertures across each small region of scan, line by line, through a number of steps equal to the number of total discreet viewable angle before repeating. In FIG. 15, the display has 18 discreet viewable angles. The pattern of the aperture plate shown in FIG. 15 indicates a rectangular grid. This scanning pattern does not necessarily need to be aligned in this manner. Alternatively, the scanning patterns could be somewhat ‘stair stepped’, or could be completely randomized. The gridded “region of scan” configuration is simply useful organizational tool.

Viewing Volume of a Two Axis 3-D Display System

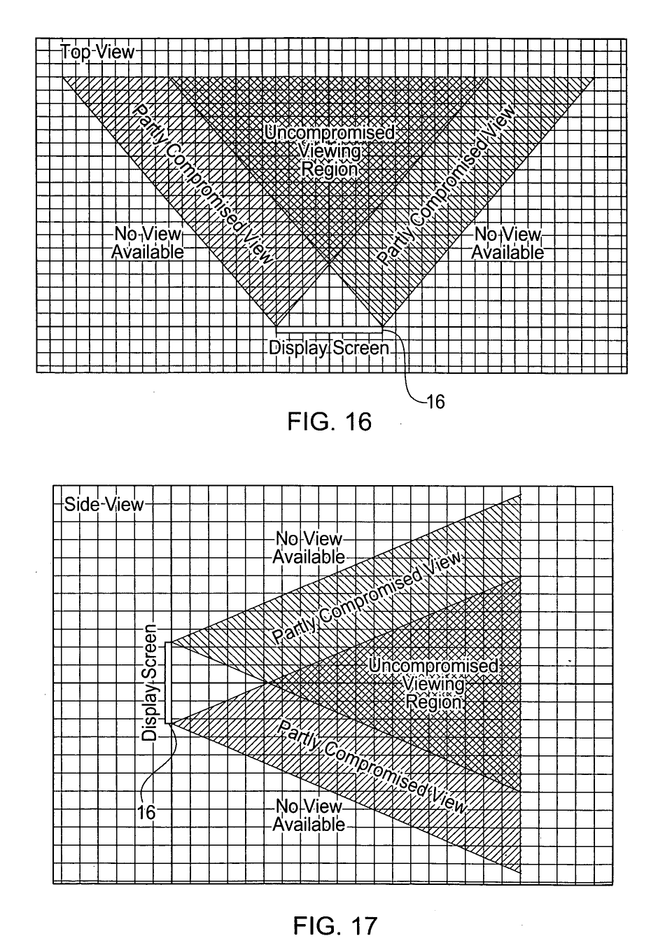

Each of the two axes of the display has a maximum viewing angle away from the normal. By projecting this maximum angle outward from either side of normals extending from the most separated apertures on the aperture plate, it is possible to determine the shape and location of the viewing area for the given display axis. FIGS. 16 and 17 demonstrate this concept. The display screen 16 shown offers a maximum horizontal viewing angle of 40 degrees, and a maximum vertical viewing angle of 22 degrees. The 3D renders of FIGS. 16 and 17, show the 3-dimensionality of the actual uncompromised viewing volume (region). Note that the fully uncompromised region is the volume of intersection between the horizontal and vertical viewing regions.

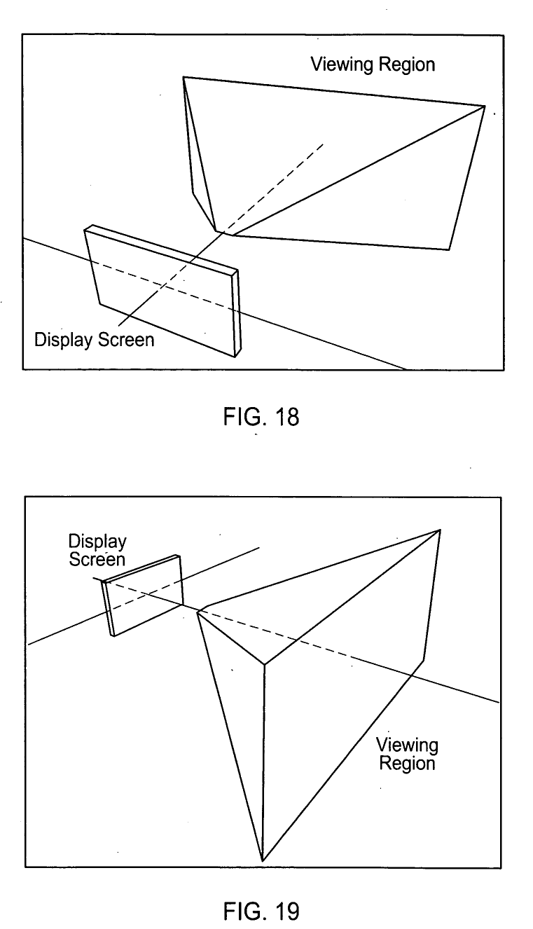

Thus, it is readily understood that any two axis display based on dynamic parallax barrier time multiplexing will have some angular limitations for a given axis, and that, taken together, the total uncompromised viewing volume will have a pyramidal, or wedge-fronted pyramidal shaped volume extending away from the display screen and separated from the screen by a certain distance. The outermost boundary of the pyramid (the reclining pyramid's “base”) is determined by the distance at which the screen's 3-D effect breaks down because of reduced angular resolution. FIGS. 18 and 19 depict the uncompromised viewing volumes from various perspectives in accordance with the two-axis 3-D display systems of the present invention.

Solid State System

As described in detail above, it is understood that three-dimensional images, having realistic angular parallax over a wide range of viewing angles, can be achieved through time-modulated image reconstruction. This can be accomplished by the use of dynamic parallax barriers (scanning apertures) in conjunction with a step-synced video display device separated at a defined distance or gap G. The following embodiments show the implementation of this technique which involve a ferroelectric liquid crystal matrix (FLCD) as a dynamic parallax barrier, and a high speed video display (e.g., FLCD) with a high-speed address bus. In practice, the ferroelectric display matrix is placed at a precisely maintained distance (gap G) from the face of the display. Such a system can, under optimal conditions, produce several discreet angles of parallax over a substantially wide range of viewing angles and can, under special circumstances, achieve color.

Under ordinary circumstances, however, it is difficult, if not impossible, to produce reliable color, brightness, and resolution at the high frame rates required by the 3D display system of the present invention using old CRT technology.

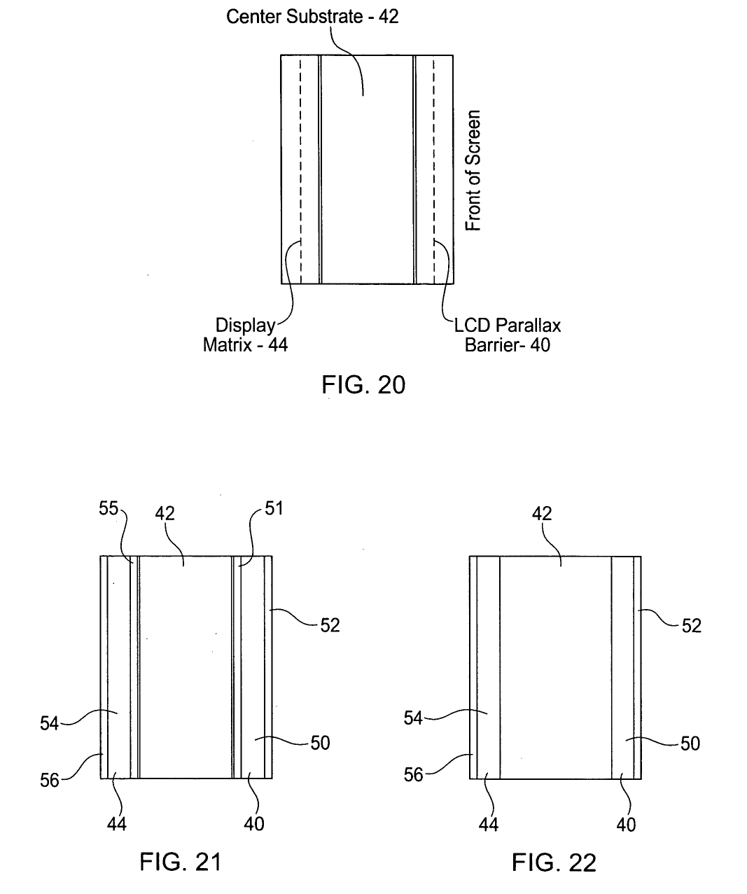

FIG. 20 shows a solid state version of the scanning aperture 3-D display system according to another embodiment of the invention. This embodiment provides a method and structure for creating a truly solid-state, high resolution, three-dimensional color display device capable of realistic angular parallax over a wide range of viewing angles comprising, by way of example, a liquid crystal dynamic parallax barrier 40 (e.g., FLCD), a transparent substrate of a specific thickness and index of refraction 42, and a high speed liquid crystal (e.g., FLCD) or OLED display matrix 44.

This solid state embodiment will have the following features: 1) no air gaps or open regions within its volume; 2) capable of producing images in realistic color and of high resolution, having pixel pitches between 1 mm and 0.25 mm; 3) capable of producing multiple viewing angles; more than 8; 4) includes a solid transparent substrate onto opposite faces of which are bonded a liquid crystal dynamic parallax barrier and a high-speed flat display matrix; 5) display is capable of a relatively wide viewing angle, maximally 90 degrees from normal for a given axis; and 6) display uses a solid-state display device capable of sustained high frame rates between 200 and 10,000 frames per second.

The display device is comprised of three solid layers. The outermost layer, facing the user, is a solid-state dynamic parallax barrier 40. This can be a high-speed LCD matrix (e.g., FLCD), alternately, it could use Zero-Twist Nematic liquid crystal technology or make use of low-cost PI-Cell liquid crystal technology. The second layer is the central substrate 42, a preferably low-density transparent material of precisely chosen thickness and refractive index. The substrate can consist of fused silica glass, acrylic, or other optical material having a suitably low index of refraction. The third layer is a solid-state display matrix 44. This may be a transmissive-type display formed from high-speed LCD technologies, which can include ferroelectric or ZTN, or can be of an electroluminescent type, such as organic LED (OLED) or plasma. According to a preferred embodiment, FLCD is used for matrix 44.

The LCD parallax barrier 40, as mentioned above, will consist of a liquid crystal matrix over whose face is an array of discreet active regions which can, by the application of electrical current, switch from being opaque to transparent, and return to opaque with the removal or reversal of said electrical current. These active regions may, in one embodiment, be shaped like tall rectangles, having width equal to or slightly larger than that of an image pixel of the display matrix, and having height extending vertically from the lowest edge of the display screen's active area to the upper most edge. This configuration will allow the construction of images having realistic angular parallax, but only in the horizontal direction. Alternately, the active regions of the parallax barrier can be rectangles whose height and width are nearly equal. This configuration will allow the display to produce images having angular parallax in both the horizontal and vertical axis. In operation, the active regions of the parallax barrier are rapidly activated in sequence so as to emulate several scanning slits or an array of pinholes. These virtual optical apertures are made to translate at a rate rapidly enough that the translation cannot be detected by the human eye.

The required optical response time for said dynamic parallax barriers is given as:
T=1/(40*v*h)
where T is the optical response time, v is the number of vertical angles to be presented, and h is the number of horizontal angles to be presented. The preferred embodiment includes a dynamic parallax barrier 40 that can sync to a video image from display 44 with a frame rate between 160 and 10,000 frames per second. To meet these requirements, the active material in the dynamic parallax barrier 40 (e.g., smectic C-phase ferroelectric liquid crystals) must have optical response times between roughly 3 milliseconds at the slowest and 5 microseconds at the fastest.

The number of transparent active elements that are open at any given moment during the parallax barrier's operation is given as by the following equations:

For slit-type configuration:
a=Rh/h
where a is the total number of open slits, Rh is the horizontal resolution of the display screen, and h is the total number of discreet horizontal angles to be presented.

For pinhole-type configuration:
a=(Rh/h)*(Rv/v)
where a is the total number of open slits, Rh is the horizontal resolution of the display, h is the total number of discreet horizontal angles to be presented, Rv is the vertical resolution of the display screen, and v is the total number of discreet vertical angles to be presented.

The transparent substrate 42 is positioned directly behind the parallax barrier 40, and generally comprises a single layer of transparent material of suitable thickness and refractive index. This layer acts, at least in part, as the structural base for both the dynamic parallax barrier and the display matrix layers. These layers preferably are bonded to the substrate layer by means of a transparent adhesive, such as an optical epoxy or resin. Other adhesive methods may include clearwelding using lasers having a specific bandwidth and absorbing dyes in the substrate or parts being bonded thereto that do not interfere with the optical properties of the substrate 42 (i.e., dyes capable of absorbing the laser light energy in the pre-determined bandwidth and in response to the absorption of the laser energy, completely bonds the two surfaces without any change in the optical properties of the bonded surfaces).

The substrate 42 preferably has uniform thickness, and refractive index over its entire area. The substrate may or may not polarize the light that passes through it. The substrate may or may not affect the color of the light that passes through it by means of dye or other subtractive chromatic filter.

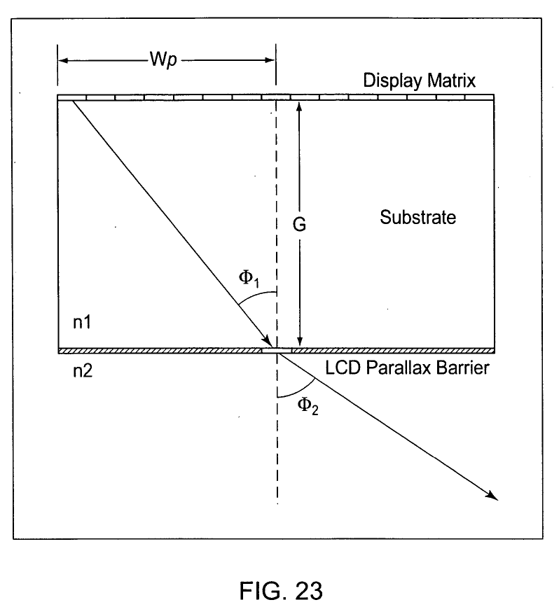

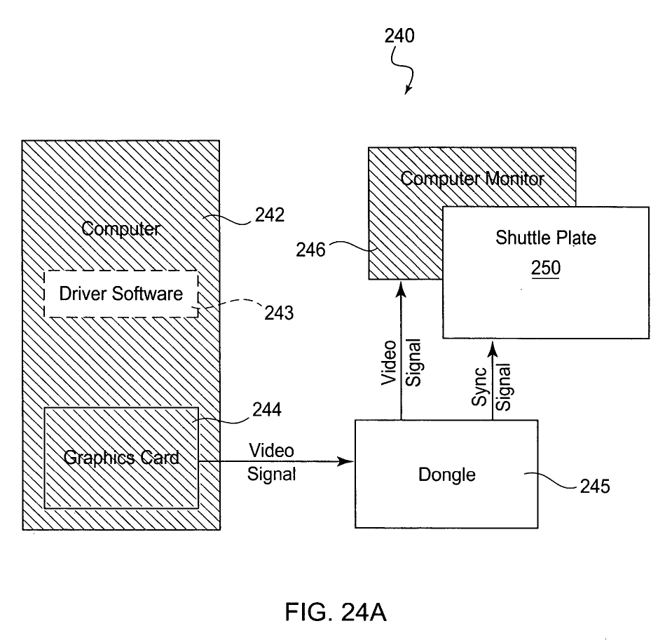

According to other embodiments, the substrate 42 can be implemented as part of either the parallax barrier (aperture plate) 40 or the display 44, or both. FIGS. 21 and 22 show various different solid state embodiments of the present invention.

FIG. 21 shows the parallax barrier (aperture plate) 40 having three layers, two glass layers 51 and 52 and an LCD layer 50 between the two glass layers, while the display 44 also has three layers, two glass layers 55 and 56 and an LCD layer 44 disposed between the two glass layers. As shown, in this embodiment, the glass layer 51 of parallax barrier 40 is adhered to the substrate 42 in any suitable known manner, and the glass layer 55 of the display 44 is adhered to the substrate 42 in any suitable known manner.

According to another aspect of the invention shown, the respective glass layers 51 and 55 of the barrier 40 and display 44, respectively, are eliminated and replaced by the substrate 42. FIG. 22 shows an example of this embodiment where the display 44 and parallax barrier 40 are integrated with the substrate in one single piece structure.

FIG. 23 and the following set of equations describes the relationship between the thickness of the substrate 42, its index of refraction, and the maximum viewing angle away from normal for a given display 44.

FIG. 23 shows a cross section of an exemplary implementation of the invention. Notice that the maximum viewing angle away from normal (Φ₂) is a function the partial projection width (Wp), the thickness of the substrate (G), and also the refractive indices of the substrate and viewing environment (n1, n2). The calculated value of Wp is given below:
Wp=PA/2
where Wp is the partial projection width shown in FIG. 21, P is the width of a given pixel on the display matrix, and A is the total number of discreet angles to be constructed by the particular display. The maximum viewable angle away from the normal for a given display is given as the following:

$${Φ}_{2} = arcsin ( \frac{n1Wp}{n2 \sqrt{{Wp}^{2} + {G}^{2}}} )$$

where φ₂ is the maximum viewing angle away from normal, n1 is the substrate refraction index, Wp is the partial projection width, n2 is the refraction index of the viewing environment (most likely air) and G is the thickness of the substrate. It must be noted that the above equation describes the viewing angle with respect to the substrate's index of refraction, but that the absolute maximum viewing angle for a particular display will be intrinsically limited by the substrate's index of refraction. Beyond a certain maximum Φ₂, the rays of light from the display screen will be subject to complete internal reflection within the substrate. The above equation was evaluated for several candidate optical materials with the following results:

| Material | n | Degrees Max. Viewing Angle |
|---|---|---|
| Fused Silica | 1.46 | 42 |
| Acrylic | 1.49 | 41 |
| Optical Glass | 1.51-1.81 | 41-32 |
| Polycarbonate | 1.59 | 38 |

From the above data, it becomes clear that lower n values for a given substrate material result in a greater maximum viewing angle. By selecting the proper substrate material, it is theoretically possible to create displays with maximum viewing angles of greater than 45 degrees. Even an angle of 40 degrees from normal (80 degrees total viewing angle) is acceptable for most applications, and is acceptable for viewing by multiple persons.

The thickness of the substrate will remain relatively thin for displays of standard video monitor resolution and relatively moderate number of discreet angles. With a pixel pitch of 0.3 mm and 100 discreet angles, the substrate will most likely be under 2 cm thick. For higher numbers of discreet angles, the substrate becomes thicker, but not unmanageably so. An extremely high angle display capable of reconstructing 500 discreet angles, having a pitch of 0.3 mm will require a substrate roughly 8 cm thick. Most practical embodiments, however, will fall in the 50-150 discreet angle range, and will be less than 2 cm thick. A minimum thickness 3-dimensional display, capable of reconstructing just 8 discreet angles, and backed by a display with 0.25 mm pixel pitch, only requires a substrate thickness of 2 mm.

It should be noted that, especially in the case of small to moderate numbers of discreet angles, and for display systems of very small thickness, a precisely maintained separation between the parallax barrier and display matrix is critical. The use of a transparent substrate is the most practical method for setting and maintaining such a geometrically perfect separation and alignment.

The high-speed display matrix 44 is the back most layer in the solid state 3-dimensional display system. It is comprised of roughly rectangular pixels, having height nearly equivalent to width, as in a standard LCD screen. In a liquid crystal embodiment, the display screen preferably would employ either high-speed ferroelectric liquid crystal, or moderately high speed Zero-Twist Nematic liquid crystal technology, or any of a variety of other suitably fast bi-refringent liquid crystal materials (e.g., smectic C-phase ferroelectric liquid crystals). The display will employ commonly practiced techniques for implementing full color production.

In one electroluminescent embodiment, the display matrix comprises one or several layers of organic light emitting polymer. The matrix is capable of producing any of a broad spectrum of colors of light from any of its pixels, and is capable of maintaining the high required frame rate. A third technology is that of plasma display, where an array of electrodes causes a gas to emit light, illuminating a matrix of fluorescent segments. This method can theoretically produce the required frame rates, but is least desirable because it requires expensive encapsulation techniques and is somewhat more fragile than the other two.

The pixel pitch of the high-speed display is comparable to standard video displays, between 1 mm and 0.25 mm in size. The pixel and parallax barrier pitch will ideally exist within this range, as images become highly course when pitch exceeds 1 mm, and unwanted chromatic diffraction effects become apparent at pitches below 0.25 mm.

The screen is capable of refreshing the entire surface of its display once for each configuration of the dynamic parallax barrier, between 150 and 10,000 times per second. In operation, the refreshing of the display screen and the parallax barrier are synchronously locked to one another.

The three-dimensional display screen is innately backward compatible as a standard monitor. In standard monitor mode, all of the active regions in the dynamic parallax barrier 40 are made to be transparent, while the rear display screen 44 is made to display video at a standard frame rate, at standard resolution.

The solid state system disclosed in FIGS. 20 and 21 can be manufactured using existing glass-on-glass processes used to produce standard LCD panels of large size. This enables the manufacture of large sized high-resolution screens.

During manufacturing, the parallax alignment of the display screen (matrix) 44 is intrinsically maintained by the system, as the dynamic parallax barrier 40 and display screen 44 are firmly bonded to the substrate 42. The substrate, being of a precise thickness, rigidly maintains the separation regardless of vibration, pressure differential, or flexure.

An advantage to the solid state embodiment herein is that the system is compact and robust. Since the system of the preferred embodiment incorporates a flat-panel display matrix comprising high-speed liquid crystal technology (e.g., Ferroelectric or Zero-Twist Nematic) or an electroluminescent display system (e.g., OLED, LED), the complete display system is not bulky or susceptible to magnetic interference or vibration like CRT technology.

Some of the unique attributes of the proposed solid state flat-screen scanning aperture hologram (3D) display device of the invention include: 1) No spinning mirrors prisms or moving parts involved in the imaging system; 2) No lasers utilized to produce holograms; 3) Displays images in full color; 4) Requires no special glasses for viewing; 5) Produces realistic angle-dependent perspective, i.e., the image is a true hologram; 6) Can accept a standard digital input; is compatible with a variety of devices; 7) Can emulate other display technologies: stereoscopic, 2D standard display; 8) Images are not bounded like a volumetric display; can appear to protrude from display; 9) Requires a lower signal bandwidth than other developing holographic display systems; 10) Offers more flexibility of design in terms of size, viewing angle, and brightness than other developing holographic display systems; 11) Utilizes well-understood electro-optical phenomenon, does not rely on quantum-effect based technology; and 12) Can be produced at lower cost than laser-based systems, using existing fabrication techniques.

Other Possible Uses and Variations:

The 3D display device of the present invention can be used to display data from medical imaging devices such as NMRI, CAT scan, PET scan, and 3D Ultrasound. In practice, it would enable doctors to actively view a patient's organs in a realistic 3-D perspective.

The device can also be used as a display for industrial design applications, including automotive and product design. A wall-sized variation of this display could enable engineers to inspect a life-sized model of a new car before it is physically constructed. Multiple display screens may be arranged to form a cylindrical display arena, which would enable viewers to walk around a displayed hologram. As an alternative to this arrangement, a horizontal display table will enable viewers to walk around smaller scale holograms. Such displays could be combined with manual input devices using haptic technology to let engineers interact directly with holographic images. Smaller displays could be used by product developers to demonstrate project designs to clients. Wall mounted holographic display could be used for advertising, or as ‘virtual windows’ in otherwise cramped apartments. Wall mounted displays may also be very useful in educational institutions such as museums and art galleries, as they could reproduce the appearance of various precious artifacts, works of art, extinct animals, or other difficult to observe items.

Those of ordinary skill with recognize that various hardware may be utilized for different component parts of the disclosed 3-D display system without departing from the spirit of the invention. The following represents an exemplary list of equivalent structures that may be implemented into the system of the invention:

I. Scan Type

Scan type describes the means by which an aperture is rapidly translated across a viewer's field of view. This is necessary to the formation of complete images from otherwise pinhole or slit like apertures.

A. Solid State scanners are the most desired class of aperture scanners for commercial scanning aperture holographic displays. Their key distinction is they use not moving parts in the process of aperture translation.

1. Flat solid-state scanners are comprised of a dense matrix of liquid crystal or similar light shutters that can be rapidly made to shift between opaque and transparent. They can most easily used to create rectangular flat-screen type displays desired by the computer industry. Ferroelectric liquid crystal optical shutters have been found to have a suitably fast response time.

2. Curved solid-state scanners describe a system identical to the flat type scanner above, but built on a curved or flexible substrate. This type may be more difficult to achieve, but can be used to create cylindrical or otherwise unusually shaped displays. Applications include immersive VR environments, public display systems, and ‘artificial transparency’ whereby an opaque object is clad with holographic displays and made to appear transparent.

II. Aperture Type

A. Slit type apertures consist of a vertical aperture with the height of a given display screen and generally having the width of a similar size as the width of a single pixel of the display screen. This is the simplest scanning aperture configuration, requiring the lowest frame rate and electronic signal bandwidth. It is limited in that it only produces horizontal perspective. (A viewer may view the left and right side of a holographic object, but will not be able to see the top or bottom of the object.) This display is well suited for low cost systems used with gaming, entertainment, and design related applications. It may also be perfectly suitable for industrial, medical and military applications. In all configurations, the screen must be oriented upright to the viewer, as a computer monitor or easel, as opposed to a tabletop.

B. Pinhole type displays' apertures are small and rectangular or radially symmetric in shape. This class of display type is capable of producing accurate perspective in both the horizontal and vertical directions. Though this requires up to the square of the slit-type displays' bandwidth, such displays are suitable for table type systems. Table type systems consist of a display oriented parallel to the plane of the floor. They may be viewed from anywhere around the display, and are generally seen by looking down onto the display's surface. Such displays are ideal for engineering, design, and architectural applications. They may also be useful for certain medical applications such as virtual or telepresence surgery. Military applications may include tracking troop movements above a three-dimensional satellite map of the battlefield. Entertainment systems include arena type displays for viewing sporting events from many different angles, as game pieces on a table.

III. Display Type

A. Direct display screens in scanning aperture displays are display systems whose active elements are placed directly behind the aperture plate, as set off by the gap. This class of display is best used to thin-screen holographic displays, suitable for laptop computers and portable equipment. Display may be limited in frame rate, and hence in angular resolution produce because of the display technology's innate response time.

1. Plasma displays are capable of producing suitable fast frame rates and brightness levels, but are rather expensive. Plasma displays are generally a screen comprising a grid of electrodes within an encapsulated volume. The electrodes selectively cause the gas to fluoresce, emitting visible light or stimulating specific color phosphors to emit light.

Plasma displays are not as bulky as other types of displays and can be built as flat, thin screens, and have been shown to exhibit excellent color, and are capable of the required high frame rates. However, Plasma displays exhibit some limitations with respect to resolution, and still require a potentially fragile sealed glass enclosure.

2. OLED or Organic Light Emitting Diode technology is emerging as a highly efficient display technology. OLED comprises a matrix made up of cells of an organic electroluminescent material that emits light of a specific color when an electric current is applied. Such displays may be capable of excellent brightness and color and power conservation.

OLED display matrices promise thin, flexible, color display screens that are capable of both high resolution and fast frame rate. OLED displays are currently being incorporated into small portable devices because of their power efficiency and high-viewing angle characteristics. OLED is, perhaps, the natural direction toward which future displays will tend

4. LCD or Liquid Crystal Displays are a matrix of small cells containing crystal particles in liquid suspension and which are re-oriented by an electric field, causing a shift in polarization, which switches light passing between a pair of polarizing filters.

LCD technology is the natural choice for portable high-resolution color video display systems. They have a low power requirement, are naturally very flat in construction, and are manufactured by a wide industry base, making them relatively inexpensive. Standard TFT LCDs are typically limited in their optical response time, which is typically in the range of 1 to 200 milliseconds or longer. This switching rate is not high enough for use in a Scanning Aperture 3-D display system, which optimally requires optical switching times well below 1 millisecond.

This is generally true of most families of liquid crystal materials. There is, however, a narrow class of liquid crystals that seems perfectly suited to high frame-rate operation: Smectic C-Phase Ferroelectric Liquid Crystals. This class of liquid crystals demonstrated as optical switches with response times ranging from 5 to 150 microseconds, or roughly three orders of magnitude faster than standard LCDs.

5. Ferroelectric LCD (FLCD) displays are perhaps the most suitable technology as it can be made to match the response time of the previously discussed solid-state aperture scanner. A more detailed discussion of FLCDs and their application to the present invention is discussed in greater detail below.

B. Rear projection type displays are suitable for lower cost displays that can be built to fit in cases similar in proportion to Cathode Ray Tube (CRT) video displays. They may also be initially the most economical way to produce the excessively high frame rates required for scanning aperture display systems.

1. High speed video projectors have already been developed for use in volumetric 3-D display systems, and may be configured to produce suitably high frame rates for scanning aperture holographic systems.

2. DLP or Digital Light Processing is an integrated circuit matrix of micro-electro mechanical mirrors used to redirect a strong light source to form an image on a display screen. Some DLP displays are rear projection based.

DLP projection systems offer the advantages of high brightness, excellent color, and high frame rate. They are most commonly used in high-resolution video projection systems, and are a proven technology. They are, however, somewhat expensive, and are innately a projection technology. This limits their use to larger format rear-projection and theatrical-type projection systems; they are not suitable for most portable or compact display applications, such as laptop computers.

3. Hybrid, or compound video projection systems use several lower frame rate projectors in tandem with shuttered outputs in order to produce a suitably high frame rate. This configuration may be unnecessarily complex to align and calibrate. The main advantage is that it utilizes already existing LCD or DLP technology.

Ferroelectric Liquid Crystals (FLC)

Like the more common classes of twisted nematic (TN) liquid crystal materials, the crystal suspension used in FLC displays exhibits a chiral, or twisted molecular orientation when mechanically and electrically unconstrained. In practice, though, a Ferroelectric Liquid Crystal Display (FLCD) differs from a standard TN or STN (Super Twisted Nematic) LCD in a few important ways.

Surface Stabilization

In the construction of an STN display cell, the liquid crystal suspension is sandwiched between two glass substrates that have been surface treated or ‘rubbed’ with a particular pattern that causes the suspension to align its chiral structure in an ordered way. The substrates can be separated by several dozen to several hundreds of microns, depending on the specific application and desired switching characteristics. Thus, there is some room for inconsistencies in the substrate separation.

In contrast, a ferroelectric liquid crystal suspension must be carefully surface stabilized to its glass substrate. It must be held to a thickness of 1 to 2 microns, which must be evenly maintained over the entire area of the display's active region. This separation is maintained by the introduction of small spherical, optically inactive, spacer particles of the desired diameter. This need for precision makes the production of FLCDs more expensive than standard TFT, and the displays are more susceptible to damage due to flexure of the glass substrate. These limitations, however, have largely been overcome by manufacturers.

Driving System

A standard LCD of the STN or TN variety may be driven either as a passive or active matrix display. Passive displays have electrodes running in the vertical and horizontal direction oriented on either side of the LCD suspension. Pixels of the LCD can be addressed by directly passing current between specific electrodes, which cross at specific regions. An inherent disadvantage to this addressing technique is that, as the number of pixels to be addressed increases, the contrast ratio between activated and not-activated pixels diminishes. This limits passive matrix displays in both their resolution and their optical response time. Larger, color STN displays commonly make use of an active matrix addressing system which uses thin transistor film technology (TFT). In a TFT addressing scheme, each pixel of the LCD is backed by one or a few transistors that are integrated directly with the glass substrate of the screen. The transistors act to amplify and switch signals sent through the bus grid to specific pixels, greatly enhancing the contrast of the overall display. The frame rates of STN LCDs are high enough to display full motion video with minimal lag. Like a standard CRT, however, the refresh rate of a TFT must be maintained above 20 to 30 Hz (typically 60 to 80 Hz) in order to prevent visible flickering.

A Ferroelectric LCD can, in theory, operate in the passive matrix mode at extremely high resolution without suffering the contrast limitations inherent in TN or STN technology. This makes it potentially less expensive to produce because it does not require the expensive and complex deposition of a TFT matrix. As an added advantage, an FLCD is free of the cyclic flickering that can be found in STN displays run at too low a frame rate. This is so because FLC maintains its optical state once set, allowing each pixel to act as a kind of direct memory until it is refreshed for the next incoming frame. By way of example, the Canon 15C01 FLCD operates flicker-free with a passive matrix at standard television refresh rates.

Duty cycle

STN or TN LCDs have duty cycles at or near 100%, meaning that each optically active region can be operated in a desired mode (activated or not) without the need for a special reset process. An activated region becomes deactivated by simply removing the electrical field from the electrodes in contact with that region.

FLCD is somewhat unusual with respect to duty cycle. Because the ferroelectric liquid crystal has a state memory, it must be electronically reset to a state (it does not return to an ‘off’ state when current is removed). Additionally, it is harmful for FLCs to be exposed to a net direct current over time. Simply put, for every period of time an FLC is given a positive charge, a negative charge must be given to that region for an equal amount of time. This relationship can be described as a voltage-time product balance, where the product of voltage and time for a positive charge must equal the product of voltage and time for a negative charge. It can also be described as a 50% duty cycle, saying that half of the FLC's cycle can be used towards image formation, while half is required to maintain the liquid crystal. FLCDs are typically run through several hundred to several thousand cycles per second. There are a variety of techniques employed to deal with the inherent 50% duty cycle of FLC in the formation of a light-switch or a display screen. The main methods are as follows:

1) Voltage—Time Product Balancing—The time spent in the recycling-state of the FLC is such that it is less than the desired display state, and the voltage spent in the shorter period of time is inversely increased so that the time-voltage product is maintained. This allows the contrast to be maintained, and also allows for the 50% duty cycle.

2) Dual Layer Approach—two FLCs are layered, one against the other. Each maintains a 50% duty cycle. A pixel of the screen is made to be opaque by selectively rotating the phase of the duty cycle of a pixel in one of the layers in the FLC. In this way, a constant contrast can be maintained, though the elements of the display are continuously reversing their states.

3) Backlight Modulation—The backlight behind an FLCD can be rapidly modulated in brightness so that it illuminates the screen only during the appropriate time in the FLC refresh cycle. This approach requires a backlight capable of rapid modulation, such as an LED or strobe light.

Color

The most common approach to displaying color with a standard STN display makes use of a deposited patterned layer of dye. Each LCD pixel can thus transmit a single color, red, green, or blue. Pixels are arranged in triads, which are coordinated in their emission to mix these three primary colors into a perceivable total spectrum of color. This is known as a spatially modulated color approach, and by way of example, is utilized by Canon in their FLCD monitor. A less common approach, often used with higher-speed, is the time modulated approach. Three or more elementary colors of light are cycled over a brief time period behind the LC matrix. The matrix consists of simple light-valves, which are then made to transmit the appropriate color by opening only during the appropriate time of the color cycle. This approach, in theory, can yield a display with three times the resolution of a spatially modulated approach. A modulated backlight, however, is difficult to create for display screens of large size and brightness.

Grayscale

Grayscale performance with FLC has its own separate set considerations. Unlike STN type displays, which can directly achieve gradation based on the applied voltage, FLC is typically high-contrast or nearly binary in this respect. In order to simulate a multi-value transmissive effect, FLC cells can be time-voltage product modulated, or, in a multi-layer system, can be refresh-cycle-phase modulated. It is also possible that some combination of these techniques may be optimal for the desired application.

Temperature

Liquid crystals of the Twisted Nematic type will function over typically a wide temperature range. It is not uncommon for a TN display to have an operating temperature ranging from −15 degrees to as high as 99 degrees Celsius. FLC, however, has a much narrower operating temperature range. FLCs manufactured by Boulder Nonlinear, in Colorado, have an optimal operating range from 20 to 30 degrees Celsius. Canon, however, has widened the operating temperature range of its FLC to be from 15 to 35 degrees Celsius. Even without an extended temperature range, FLC will function normally in standard room-temperature environment, but may experience a reduction in performance from moderate temperature variances.

According to one preferred embodiment of the scanning aperture 3-dimensional display device of the invention using FLCD; 1) The FLCD screen is capable of producing a sustained display frame rate between 160 and 10,000 frames per second; 2) The high-speed video display screen used for the purpose of parallax reconstruction in the present 3-D display system can use Smectic C-Phase Ferroelectric Liquid Crystal as its electro-optic medium; and 3) The FLC will be surface stabilized between two large-format glass substrates with a total surface area greater than 16 square inches. Maintenance of substrate separation will be accomplished by means of particulate spacers of known diameter, placed between substrates, and surrounded by the FLC suspension.

In the case of the use of a solid central substrate in the Scanning Aperture 3-D Display System (see FIGS. 20-23), the FLC will be stabilized directly to the glass of the thickened center substrate. This configuration offers the following advantages:

1) Simplified overall system design, eliminates unnecessary glass layers;

2) Allows for perfect geometric alignment of FLCD with respect to front-layer aperture plate; and

3) The thickened center substrate (up to 2 cm thick) provides excellent structural support for the somewhat fragile FLC;

4) The FLC achieves color through the spatial modulation technique: A deposited layer of dye is patterned in front of or behind the active FLCD elements. Each pixel can thus transmit a single color, either red, green, or blue. Pixels are arranged in triads, which are coordinated in their emission to mix these three primary colors into a perceivable total spectrum of color. This is desirable over the use of the time-modulated technique because the time dimension will be utilized for the purposes of display-angle multiplexing;

5) In order to simulate grayscale, FLC cells can be time-voltage product modulated, or, in a multi-layer system, can be refresh-cycle-phase modulated. Some combination of these techniques may be optimal for the desired application.

6) The Ferroelectric Liquid Crystal is maintained at a 50% duty cycle. It achieves suitably high contrast by means of time-voltage product balancing, and/or by the use of multiple layers of FLC.

7) The 3D display will operate at room temperature with no special considerations made for the temperature range of the FLCD. Alternately, if the 3D display device is required to operate at low or varying temperatures, a temperature-regulated resistive heating element may be incorporated into the design of the FLCD enclosure. This would be most practical for outdoors or military applications.

8) The FLCD may be driven by a modified passive-matrix configuration. This configuration makes use of the FLC memory, which maintains the optical state of the FLC until the next refresh cycle. The bus system may be configured to allow for simultaneous addressing to multiple FLC cells, allowing for extremely high refresh-rates. The bus system may make use of TFT decoding electronics placed between columns and rows directly on the display screen substrates. Alternately, the column and row decoding electronics may be placed at the periphery of the display screen, or on a separate driver card.

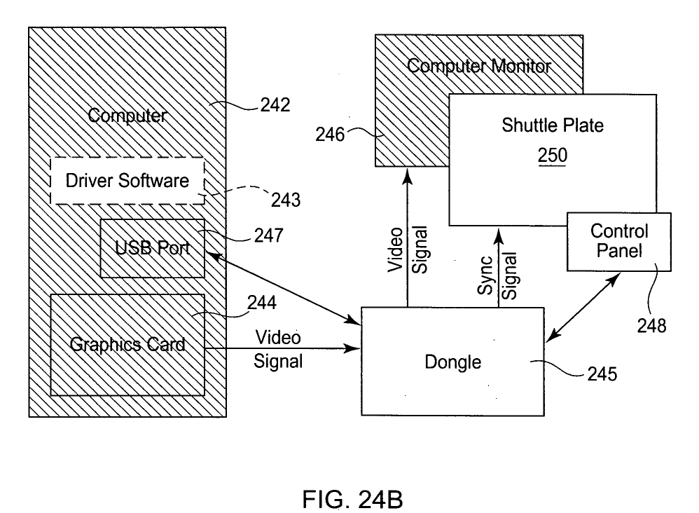

According to other contemplated aspects of the invention, it is preferred to retrofit existing display devices with the ability to provide stereoscopic display of interactive graphics. In accordance with one preferred embodiment, the system for autostereoscopic display 240 includes three major components, shown in FIG. 24a, which are a liquid crystal shutter plate 250, a hardware monitor-interface box, or “dongle” 245 and the display driver software 243.

In the example provided, the retrofit is adapted to work with any standard computer system to enable users to view computer games or other real-time 3D content in stereoscopic 3D. This is accomplished by means of a liquid crystal parallax barrier window, aperture plate or shutter plate 250 that is placed in front of a standard flat-screen display 246 and associated drivers, interfaces discussed below. The display screen 246 can be, for example, a CRT, a plasma screen, or a suitably fast LCD. The display screen 246 must be capable of achieving a continuous 100 to 120 Hz refresh rate and can be controlled by any video or graphics card 244 that is capable of supporting stereoscopic rendering for LCD shutter devices. For example, NVidia produces a card with native support for stereoscopic rendering in their GeForce, Quattro2, and TNT/Vanta GPUs (graphics processing units). Those of ordinary skill will recognize that many other third-party stereo drivers exist for other brands of cards such as, for example, ATI and Matrox. Should an LCD be the chosen display type, an additional consideration is the matching of the polarization of the LCD to that of the liquid crystal shutter plate. Since an LCD emits only polarized light, a mismatch in polarization will result in undesirable dimness or artifacts during operation with any retrofitted liquid crystal shutter.

The dongle 245 is a monitor interface and can be an external box that connects to the VGA or other display monitor connector on the CPU 242. The display monitor 246 is connected to an appropriate connector on, or stemming from, the dongle 245. Likewise, the shutter plate 250 is connected to the dongle 245 by means of a connector jack. The dongle 245 is powered by means of a standard AC or DC power supply depending on the particular application.

According to one embodiment, the dongle 245 may include a specialized chip-set designed to work in conjunction with the video data output from the graphics card 244, and may therefore be responsible for the graphical operations responsible for the positioning of the viewer “sweet spot” (discussed below in alignment embodiments). The ‘specialized chip set’ would be a proprietary chip that electronically implements a two-angle version of the image formatting algorithm. It has as its input the two previously ‘page-flipped’ frames rendered by the video card. These previous images are the separate left and right eye views, as created by the card when running in the page flipping mode, as dictated by the stereo 3D driver. The proprietary chip is responsible for interleaving vertical strips of the left and right eye views to form two new output frames that are shown on the CRT. The two new output frames are each comprised of strips from both the left and right eye views. The source image for each strip is reversed from one output frame to the next, such that the sources for output frame one will read: LRLRL and the sources for output frame two will read: RLRLR. The proprietary chip may then have the ability to vary the chosen strip widths and horizontal positioning, thus influencing the position of the sweet spot.

The chip would have the following components: A frame buffer for holding a minimum of two rendered frames from the video card, and a small processor that applies the two-angle formatting algorithm to form two output frames.

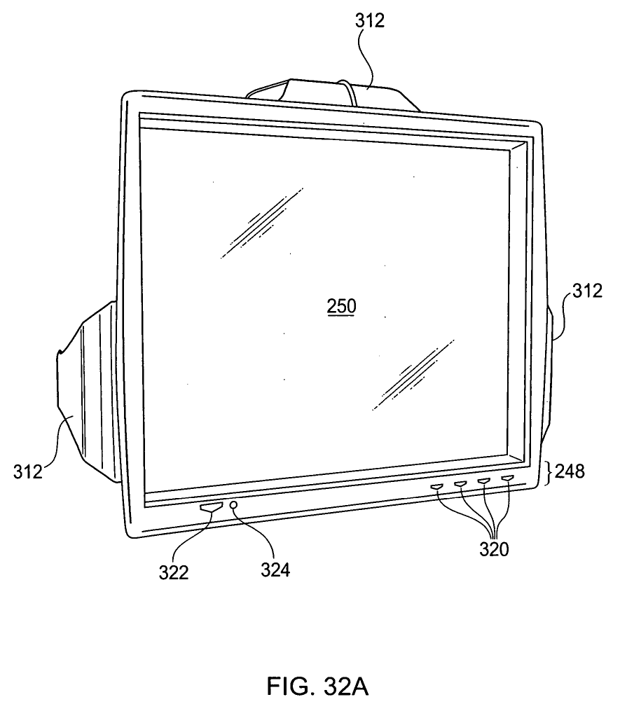

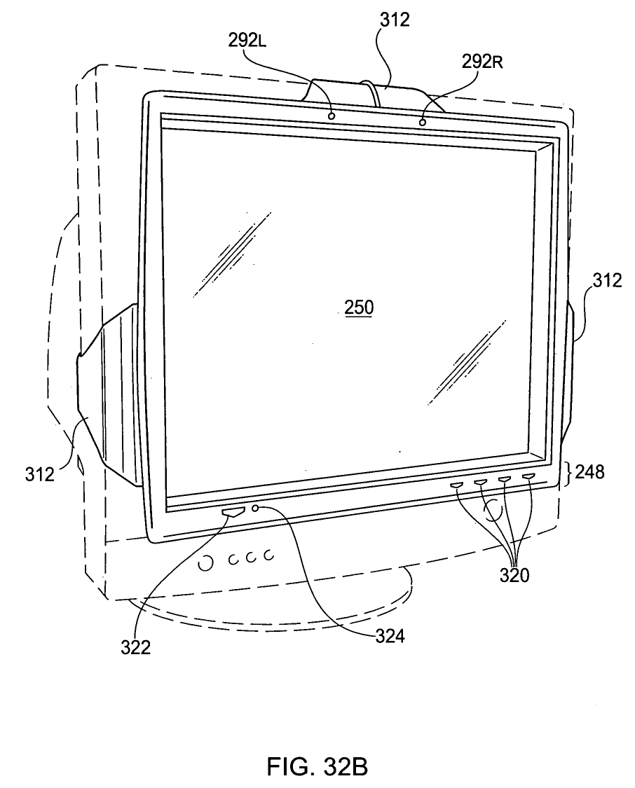

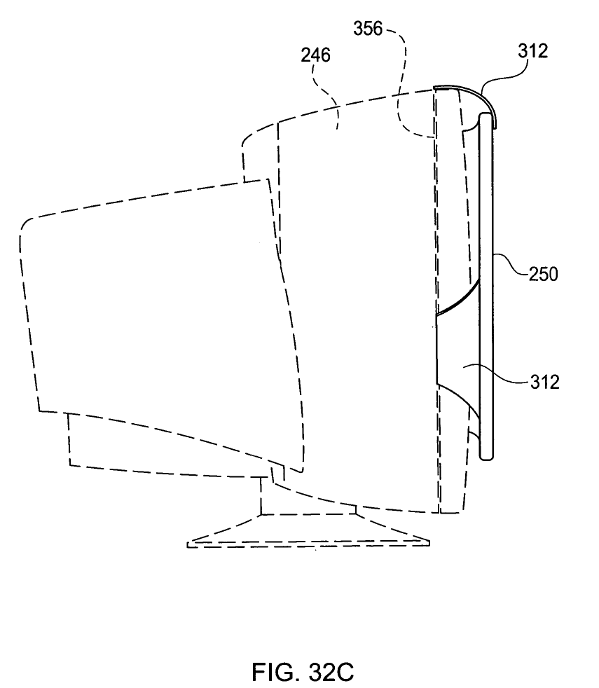

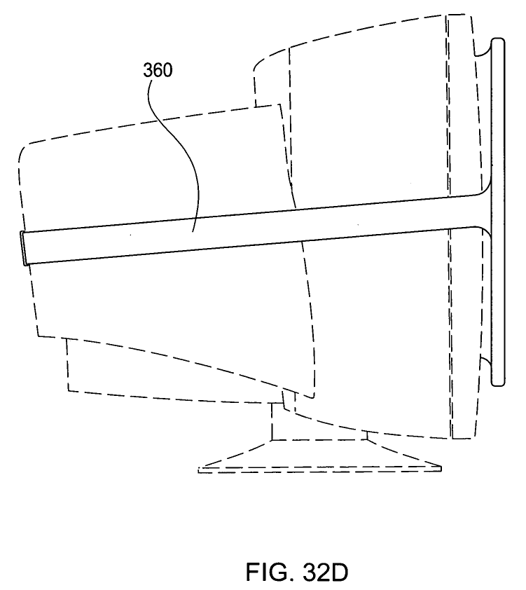

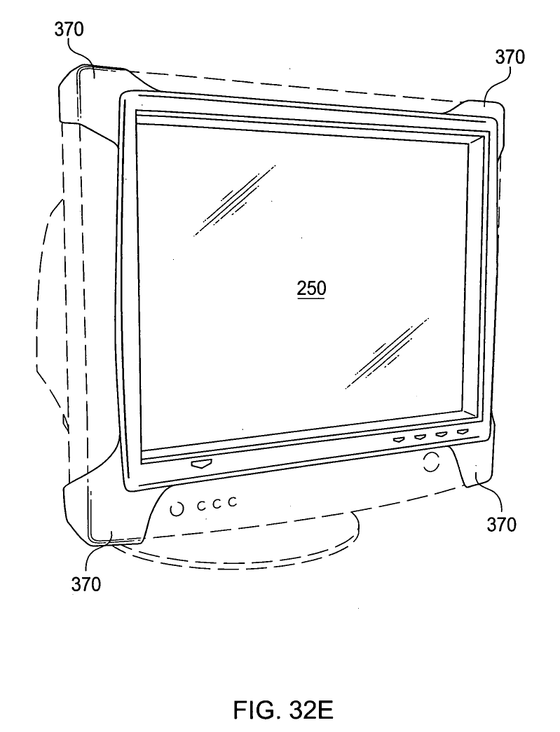

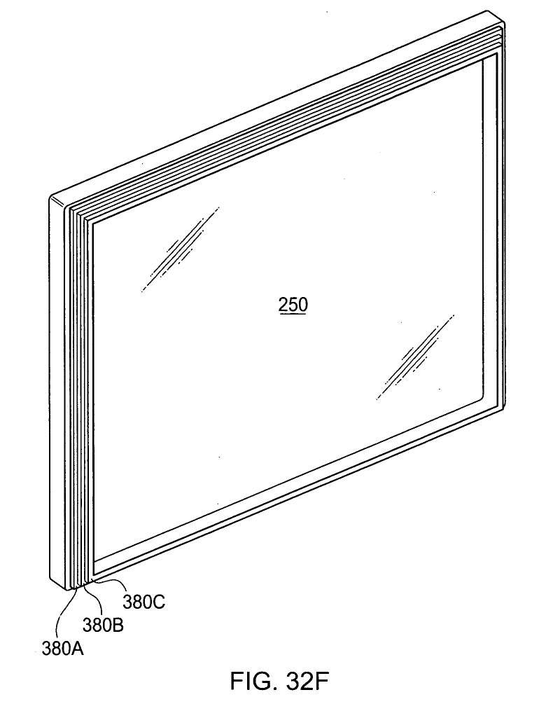

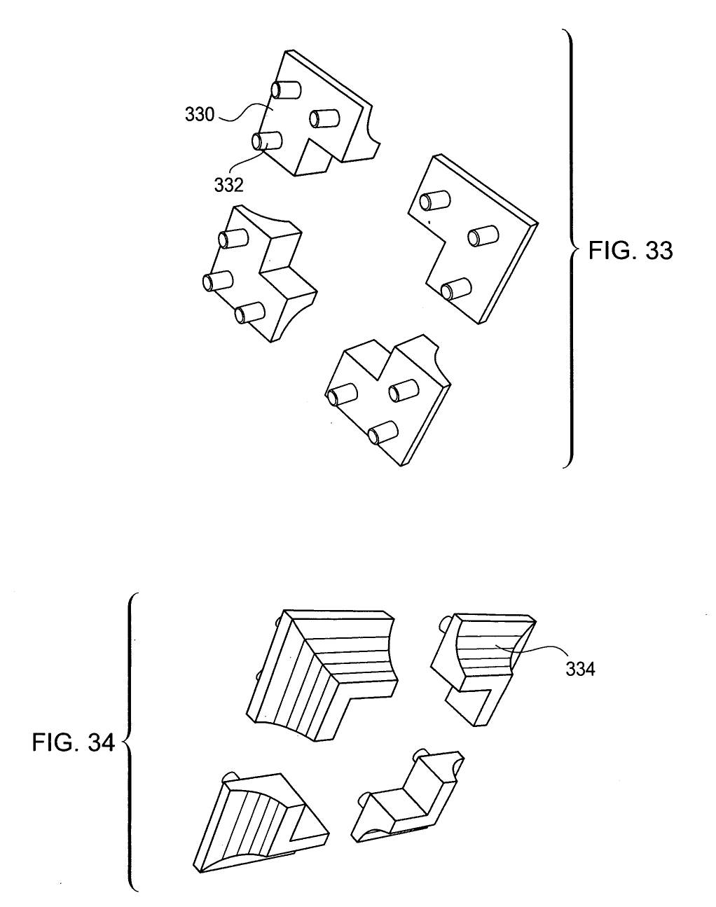

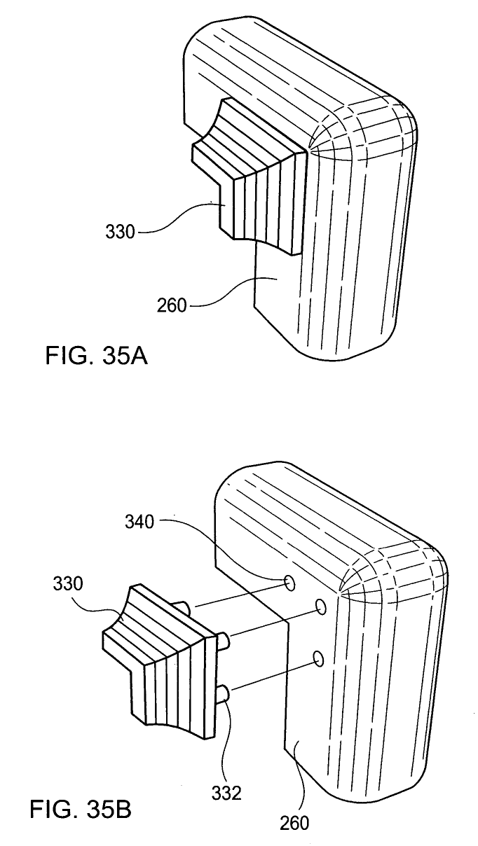

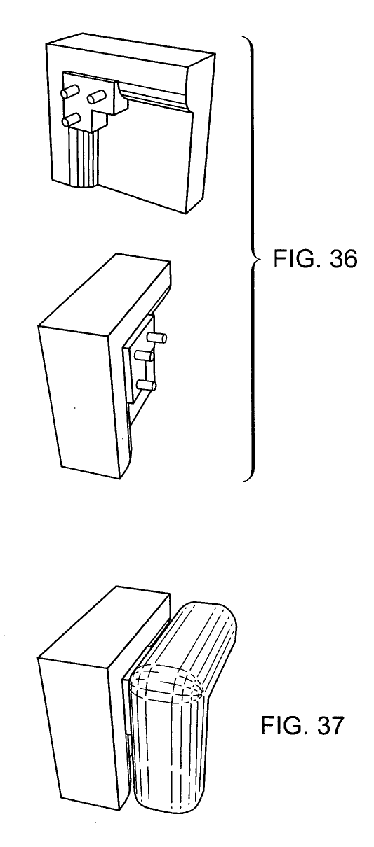

In this case, the dongle 245 will receive user input regarding the positioning of the “sweet-spot” via its connection to the shutter plate 250, which will, in this case, have control buttons on its front face (See FIG. 32).

Alternately, the dongle 245 may be a standard sync-splitter box of the type and standard used for LCD shutter devices (e.g., glasses). In this case, it functions to separate sync from the video signal, and rout it to the shutter plate 250. All control over the positioning of the viewer “sweet spot” would be managed by the driver software 243 in conjunction with the CPU's internal graphics card 244.

The display driver software 243 or stereo driver can render a stereoscopic output for any application that uses the OpenGL or Direct3D APIs by intercepting the 3-D geometry in the GPU and then generating a parallax offset image. This produces two, left and right eye-appropriate images for each frame of video requested by the application. The images are then time-multiplexed by a technique known as page-flipping, wherein the video card rapidly alternates the left and right eye views. The page-flipped images are then directed to the appropriate eyes by blocking the opposite eye for each eye-exclusive image. The left eye (i.e., the left eye view) is shuttered closed when the right-eye-appropriate image is being displayed and vice versa. When installed, the display driver software 243 of the invention provides a basic user interface that allows the user to switch between the viewing of 2-D and 3-D content by means of assigned keyboard “hot keys” or command combinations. The stereo driver can render a stereoscopic output for any application that is using the OpenGL or Direct3D APIs by intercepting the 3-D geometry in the GPU and then generating a parallax offset image. This produces two, left and right eye-appropriate images for each frame of video requested by the application.

The video graphics card is directed by the driver software to output two views, one for left and one for right eye views. The card then is responsible for interleaving vertical strips of the left and right eye views to form two new output frames that are shown on the CRT. The two new output frames are each comprised of strips from both the left and right eye views. The source image for each strip is reversed from one output frame to the next, such that the sources for output frame one will read: LRLRL and the sources for output frame two will read: RLRLR. The driver program may then have the ability to vary the chosen strip widths and horizontal positioning. Making the strip widths wider has the effect of moving the sweet spot closer to the plane of the screen, and moving the strips horizontally to the left has the effect of moving the sweet spot to the right of center.

The present invention employs an amended driver process in which the two output images are then spatially multiplexed. Spatial multiplexing consists of dividing the rendered images into vertical columns of widths roughly equal in width to the optically active columns of the shutter plate 250. The pixel information in alternating columns is then directly swapped between the two rendered images. The images are then time-multiplexed by a technique known as page-flipping, wherein the video card rapidly alternates the left and right eye views. The page flipping sequentially displays two different frames at a frequency at or above 40 Hz, and so requires a progressive monitor refresh rate at or above 80 Hz.

When the two images are temporally multiplexed, a full-resolution autostereoscopic image is reconstructed. The position of the viewing “sweet-spot” is determined by the placement of the column-divisions in the spatial multiplexing stage. By changing the placement of the column divisions, the sweet spot can be effectively set to different distances from the screen.

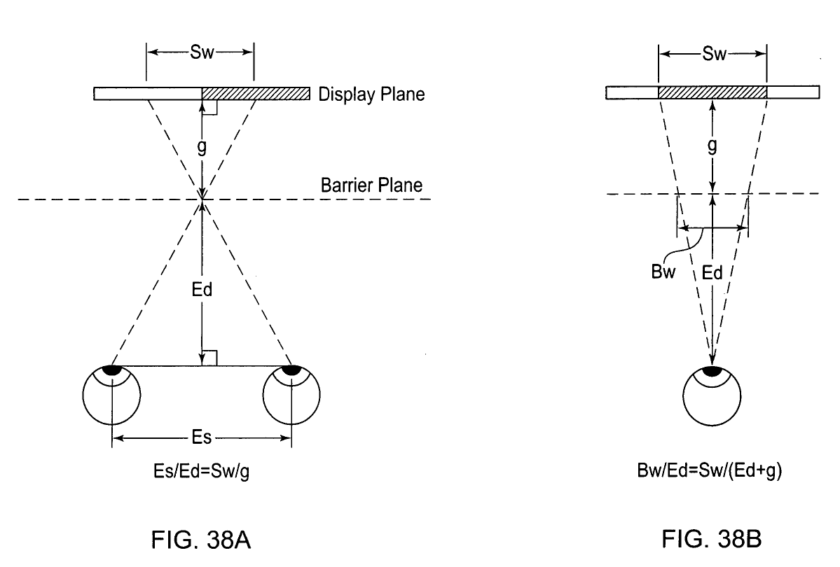

A graphic description of the relationship between the parallax barrier placement, the viewer placement, the viewing area, and the width of the barrier openings with respect to the display screen is given in FIGS. 38a and 38b. The following equation is used to scale image strips, gap and viewing distance (FIG. 38a):
Es/Ed=Sw/g
where Es is the eye separation, Ed is the eye distance from the surface of the barrier plane along a line that is normal to the display surface, Sw is the width of an individual strip of interleaved image as shown on the display, and g is the gap or distance between the parallax barrier and the display screen.

The following equation is used to scale parallax barrier openings:
Bw/Ed=Sw/(Ed+g)
where Bw is the width of a given barrier strip (or opening) within the parallax barrier.

Both equations are clearly represented in the Figures, as triangles A, B1, C1 and A, B2, C2 are similar and therefore directly proportional.

In the event that the dongle 245 is responsible for the management of the viewer “sweet-spot”, the driver software 243 will manage only the page-flipping portion of the rendered views, and the dongle 245 will then spatially multiplex them in relationship to the parallax barrier positions.

This combination of spatial and time multiplexing thus has two distinct advantages over existing designs. Firstly, the positioning of the autostereoscopic “sweet spot” is highly flexible and controllable by the user without any moving parts, and secondly, the full resolution of the original display screen is maintained. Because the full resolution is maintained, the invention provides the added benefit of being able to display 2-D and 3-D content in usable form at the same time on the monitor. Alternately, the system can simply render the shutter plate 250 transparent, revealing the display screen for direct 2-D use.

A preferred embodiment of the invention is shown in block diagram in FIG. 24a. In operation, the user sits at a computer station having a monitor fitted with the invention. A real-time 3-D application is launched, and the user uses a keyboard command to toggle to 3-D mode. This activates the shutter plate 250 and the “page-flipping”/spatial multiplexing of the images rendered by the graphics card 244. The user may now choose to adjust the “sweet spot” of the screen, or may simply proceed to use the program. The display system continues to provide full-resolution autostereoscopic imagery to the user until the program is terminated, or the user chooses to toggle into 2-D mode.

FIG. 24b shows an alternate embodiment which includes a connection between the USB port 247 and the dongle 245, and the addition of a control panel 248 to the housing of the shutter plate 250. The control panel 248 allows additional ease of access to the display driver settings. In contrast to existing systems, most game software currently makes extensive use of keyboard function keys, and as such, problems are often encountered when attempting to access the stereo-graphics driver controls. The control panel 248 of the shutter plate may include controls 320 (See FIG. 32) for setting the eye separation and convergence, for making course adjustment to the optimal viewing distance (sweet spot positioning) and will also have a control 322 for activating and deactivating the shutter plate and 3D driver software, allowing an easy switch between 2D and 3D.

Because the shutter plate 250 of the invention is an external device, it can be removed and installed on a different monitor or display. Its simple construction and ease of implementation makes it a cost-saving alternative to the purchase of stand-alone autostereoscopic displays, while its unique spatial/temporal multiplexing produces imagery of superior resolution compared to existing stand-alone displays.

The shutter plate 250 is preferably connected by means of a single cable to the interface dongle 245 at the rear of the computer CPU 242 and receives its power and timing signals through the cable. Alternatively, the shutter plate 250 may have a second cable (not shown), which provides electrical power for its operation.

According to a preferred embodiment of the invention, shutter plate 250 consists of PI-Cell liquid crystal. The liquid crystal window is electronically converted into the transparent PI state upon activation of the computer's display system by means of internal driver electronics. The liquid crystal will be optimized for the maximum viewability of colored (RGB) light passing through from the display screen, typically having its first minima set for light of 550 nm wavelength. In operation, the PI-Cell liquid crystal will be electronically driven by means of an internal driver circuit in such a way that artifacts known to PI-Cell LC are minimized and contrast ratio at desired frequency is maximized. Such driving techniques may include, but are not limited to the use of a quasi-static waveform, or that of an alternating unipolar carrier waveform, as described by Lipton, Halnon, Wuopio, and Dorworth in “Eliminating PI-Cell Artifacts” 2000.

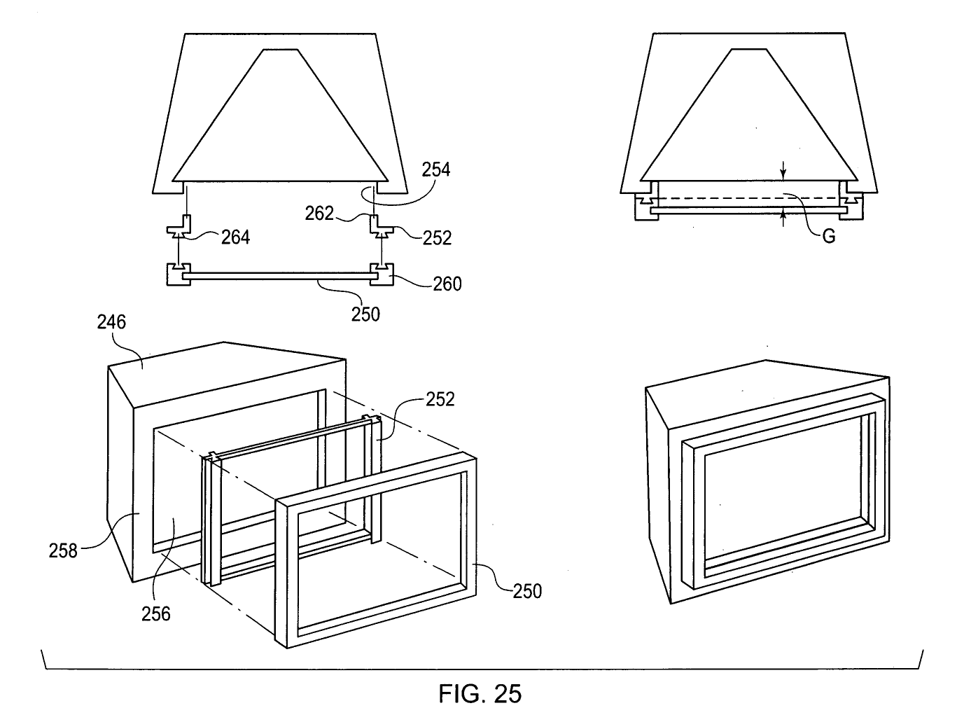

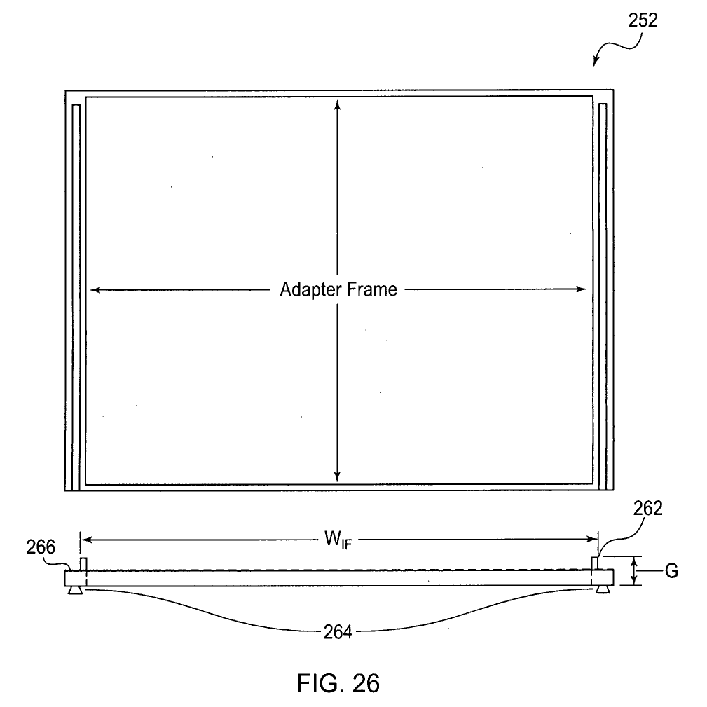

FIGS. 25 and 26 show the mounting of the shutter plate 250 onto a display monitor 246 according to an embodiment of the invention. The shutter plate 250 is affixed to the front of the monitor 246 by means of a separate adapter frame 252, which on one hand, fits exactly into the front frame 254 of the intended computer monitor 246 with the aid of flanges 262, secondly has the appropriate physical thickness for the necessary gap G, and thirdly interfaces with the shutter plate 250 using shutter plate mounting rails 264 or the like, in a way that allows its sturdy support and also facilitates its removal. As shown, the adapter frame 252 fits perfectly into the front of the intended monitor since flanges 262 are distanced at a width WIF equal to the monitor frame inner width, and may be affixed by means of glue, hook/loop strips, or self-adhesive strips, connecting the ‘seating surface’ 266 of the adapter frame 252 to the front surface 258 of the monitor's outer frame 254. The adapter frame 252 mechanically interfaces with the shutter plate 250 unit by means of a complimentary groove (268)/rail (264) relationship. This allows the shutter plate 250 to be slid down onto the adapter frame 252, where it is held snugly, while allowing for easy removal.

The shutter plate 250 is separated from the display screen's display surface 256 by a specific and carefully maintained gap G, or separation. In practice, it is important to consider the distance of the monitor's display surface behind the glass of the tube or transparent front when determining the actual optical gap G. When considering the glass front of a monitor 246, it is also important to consider the effects of refraction by the glass on the light exiting the front of the tube towards the parallax barrier. The precise gap G is maintained by firmly affixing the shutter plate 250 to the front frame 254 of the intended monitor 246 by means of the adaptor frame 252.

According to other embodiments of the invention, shutter plate 250 is designed to be compatible with same-sized monitors of different brands. As such, it is possible that each particular brand of monitor requires a specific type of adapter frame 252, which assures that the shutter plate is placed in proper relationship with the display surface, regardless of brand-to-brand differences between the monitors' outer frames. For this reason, it is to be understood that the finished embodiment of the invention may simply be shipped with several different adapter frames 252, one of which will suit the user's particular display screen.

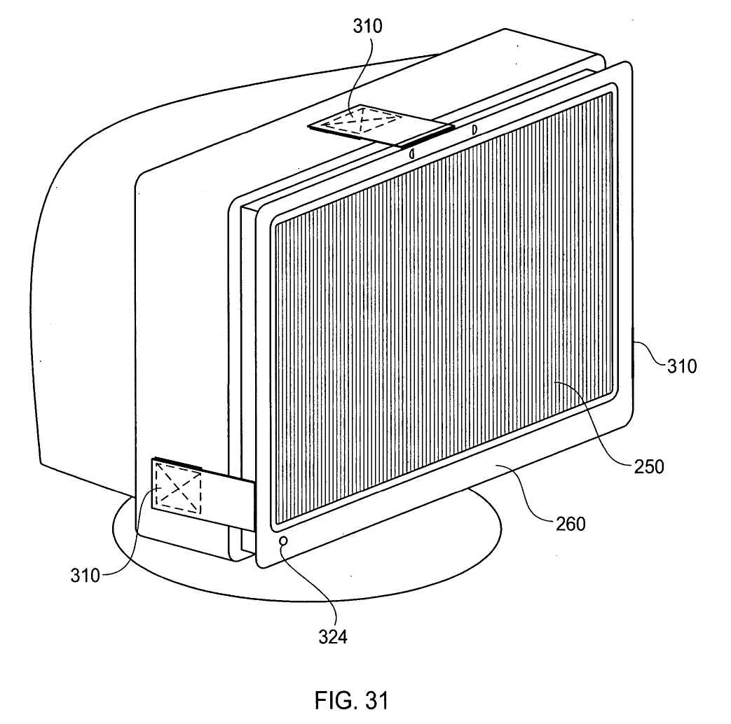

As an alternative to adhesion, the adapter frame 252 may be connected into the front of the monitor by means of pressure, or may be constructed to ‘snap’ into the front of the monitor's frame (e.g., using flanges 262), or to make use of the seam around the monitor's outer edge as a means of stabilization. This may be accomplished by means of brackets that ‘wrap around’ the edges of the monitor in order to reach this often-thin seam. By way of example, the shutter plate 250, with adapter frame 252 attached, is then seated snugly to the front of the display 246. The overall shutter plate 250 with adapter frame 252 can be attached to the monitor by means of connectors 310 such as, for example, brackets, press in fittings, and/or elastic straps that attach to the outer shell of the display monitor by means of self-adhesive hook/loop material (See FIGS. 31-32e). The connectors 310 can be placed on either side and at the top of the display 246. Elastic straps are preferred (as opposed to non elastic straps) as the elastic provides light yet constant force, which serves to hold the shutter plate 250 snugly in place on the front of the monitor 246. The connectors (e.g., elastic straps) 310 and hook/loop fasteners do not need to support any weight of the shutter plate 250, which is supported primarily by means of the adapter frame 252. The entire shutter plate 250 can be easily and quickly removed by pulling the connectors 310 loose from the monitor shell, and pulling the shutter plate out of the inner frame 254. When removed, only the self-adhesive hook/loop material patches remain on the monitor shell.

A method may also be employed to mount the shutter plate 250 to the monitor 246 by means of a direct connection between the shutter plate and the monitor, rather than by means of a connection between the adapter frame and the monitor. In this case, self-adhesive tabs may be used in order to join the shutter plate to the frame of the monitor. (need to show adhesive) As an alternative, the shutter plate 250 may make use of the seam 356 around the monitor's outer edge as a means of stabilization (see FIG. 32c). This may also be accomplished by means of connectors 310 that “wrap around” the edges of the monitor in order to reach this often-thin seam. As another alternative, the shutter plate 250 may be held in place by pressure provided by a rubber strap 360, or a connection to a rubber strap 360 that stretches around some part of the display screen (see FIG. 32d). The rubber strap 360 may be adjustable in length to allow the shutter plate 250 to be used on more than one size display monitor. The rubber strap 360 could alternatively be replaced by a rectangular ‘boot’ 370 that stretches over the outer four corners of the front of the screen (see FIG. 32e).

In the case that an adapter frame 252 is not used, the housing 260 of the shutter plate 250 is fitted snuggly into the frame of any of a variety of monitors by means of a multiple-stepped set of bevels 380a-380c around the screen-facing edge of the shutter plate. (see FIG. 32f). The size of each beveled level corresponds precisely to the frame size of a particular monitor brand. This method requires that the driver software 243 compensate for slightly different gap lengths for different monitor brands, as the specific bevels corresponding to different monitor types are set at different heights.

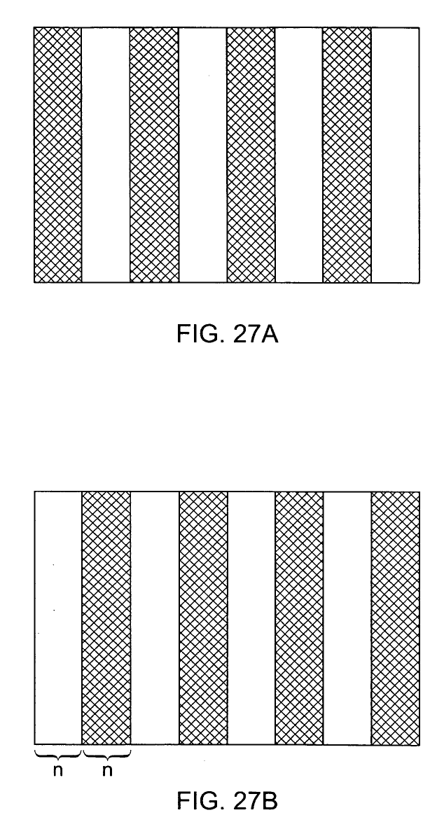

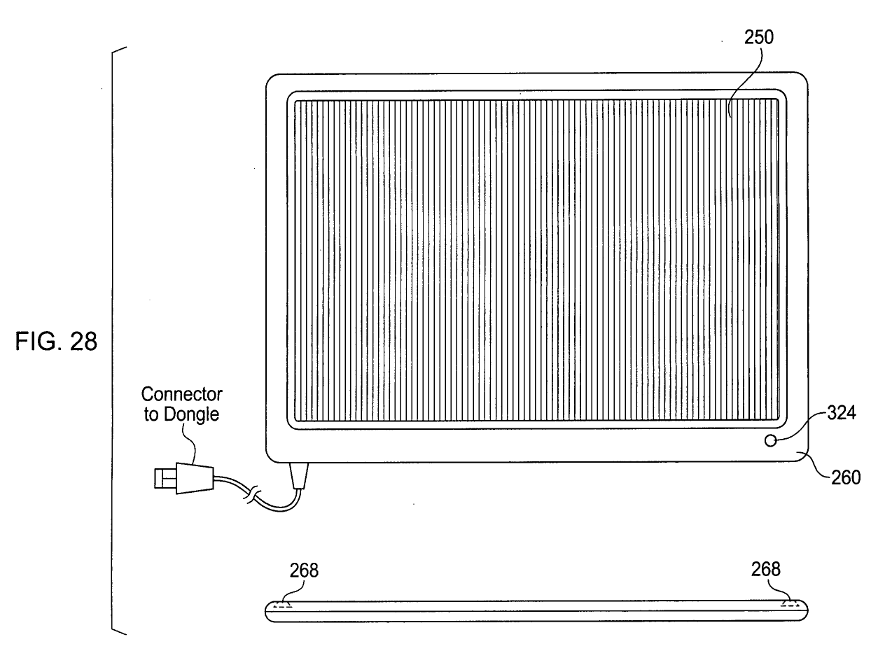

In accordance with a preferred embodiment, shutter plate 250 consists of a rectangular liquid crystal window the size of the intended display screen's visible display surface (See FIG. 28). The shutter plate liquid crystal window 250 consists of a number of optically switchable regions n arranged across its area as a series of vertical columns (See FIGS. 27a and 27b). The columns adjoin each other in such a way that there is virtually no gap between them. The columns are vertically as tall as the entire optically visible portion of the window and have widths equal to or greater in width than the width of pixels displayed on the intended display screen. The columns are intended to be electronically cycled between alternating states, as pictured as FIG. 27a and FIG. 27b. The cycle frequency between the optical states of the elements of the shutter plate must be 50 Hz or higher, and will correspond to half the refresh rate of the intended display screen when in operation.

The autostereoscopic retrofit system 240 of the present invention provides a means for viewing images in 3D. However, in order for the observer to perceive the depth created by the system of the invention, the user's eyes must be positioned within specific viewing zones with respect to the display screen so that each eye receives the appropriate separate image from the display. Thus, an alignment mechanism must be employed to assure the proper operation and function of the system 240 of the invention.

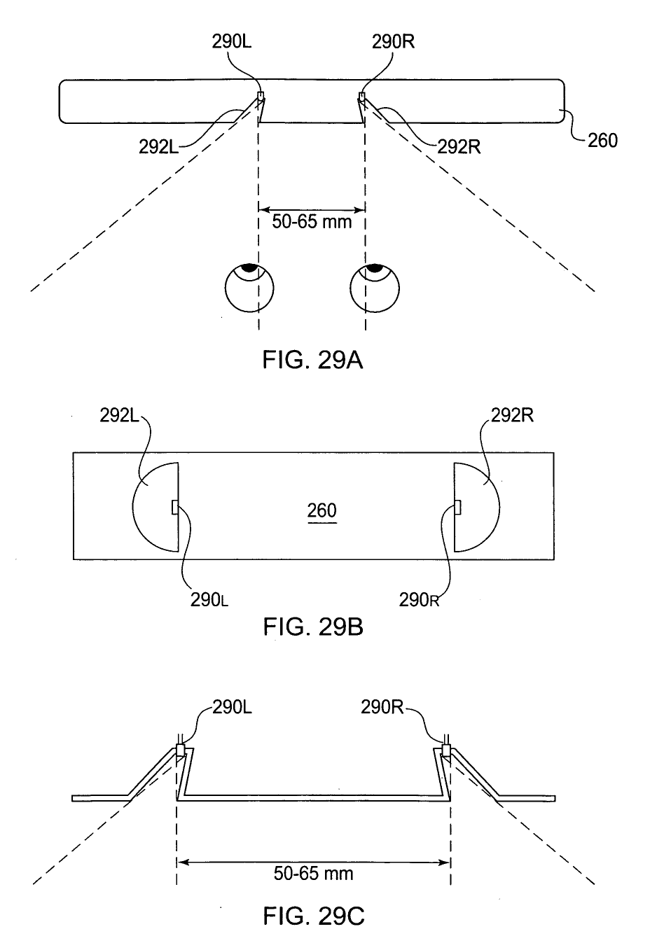

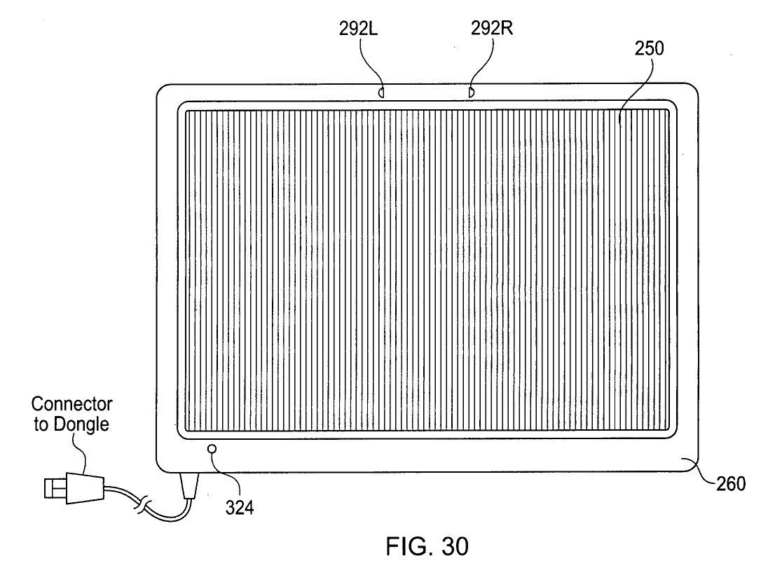

In accordance with the alignment aspect of the invention, a pair of dimly lit LEDs 290_{L} and 290_{R} are set in the back of a pair of specially shaped indents 292_{L} and 292_{R} in the plastic enclosure frame 260 surrounding the shutter plate liquid crystal panel 250. (See FIGS. 29a-29c and 30). LEDs 290_{L} and 290_{R} are described herein as an exemplary embodiment of the alignment system of the invention. Other light sources may also be implemented without departing from the spirit of the invention. The LEDs 290_{L} and 290_{R} are horizontally separated by a distance in a range between 50 and 65 millimeters, which is estimated as roughly the separation between the pupils of human eyes. The indents 292_{L} and 292_{R} are angled such that the inner edges sharply block the light of the LEDs when the user's eyes are beyond a specific viewing angle for each light. According to some exemplary embodiments, the “sweet-spot finder” could pinpoint a region as narrow as less than 1 degree, or could be useful for ranges as high as 20 degrees.

In operation, the viewer uses the LEDs 290_{R} and 290_{L} to position his/her head before the parallax barrier or shutter plate 250. When the head is misaligned, only one of the pair of LEDs or lights will be seen to glow. When the user's head is properly positioned before the display, both lights will be seen to glow, one by each eye. There will be some degree of horizontal head movement for which both eyes will be seen. This range of motion is dependant on the specific geometry of the indentations 292. The range can be wide enough to tolerate as much as an inch or more, or may be restricted to be as small as ¼″. The range over which both lights are visible will be optimized to accurately reflect the optimal viewing region, or “sweet spot” of the autostereoscopic display.

When the autostereoscopic retrofit panel or shutter plate 250 is first seated on the front of a monitor or other display screen 246, the system must be first calibrated so that the alignment lights are useful and meaningful. The calibration process consists of the following steps: 1) seating the LC shutter plate 250 on the front of the monitor 246; 2) positioning the head so that both alignment lights 290 are seen to glow; and 3) adjusting the monitor 246 and 3D driver controls 243 so that a digital test pattern exhibits satisfactory stereoscopic separation. Once this process has been performed, the user may move freely, and can easily find the autostereoscopic-viewing zone again by using the alignment lights 290.

As shown in FIGS. 28, 30-32 the shutter plate 250 is built with an LED 324 that signals it is in operation, but may be devoid of any controls or buttons. In this case, all settings for alignment and stereoscopic viewing are entirely managed through the driver software 243, controlled by means of the keyboard. Alternatively, the shutter plate 250 may be made with its own control panel 248 (See FIGS. 24b and 32) and include control buttons 320 placed on its front, in a manner that they do not interfere with the buttons on the original display monitor. As discussed above, control buttons which are part of control panel 248, will provide an external control mechanism by with the user may set the desired viewer sweet-spot position, and possibly the parallax convergence of the source images. The buttons provided on frame 260 may also include a switch 322 for turning the shutter plate on/off, switching between 3D and 2D operation.

According to one preferred embodiment, the shutter plate 250 will ideally be framed in a way that makes it aesthetically appropriate for the users and content being displayed. For example: for gaming applications, the frame 260 of the shutter plate 250 will be made with the appearance of “organic” or highly stylized “high-tech” surface detail, and will have appropriate coloration such that it compliments fantasy/science-fiction themed video games.

While there has been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

1. An apparatus for retrofitting a 2D display monitor used with a computer for auto stereoscopic display comprising:
a shutter plate positioned in front of and releasably attached to the display monitor; and
an interface device connected to the display monitor, computer and the shutter plate, said shutter plate and said interface device operatively provide stereoscopic display to a user of the 2D display device.

2. The apparatus according to claim 1, further comprising a connection system for releasably attaching said shutter plate to the front of the display monitor.

3. The apparatus according to claim 1, further comprising video drivers stored in the computer for synchronizing operation of the shutter plate with software being run on the computer.

4. The apparatus according to claim 1, wherein the display monitor is one selected from a group consisting of CRT, plasma, OLED, DLP rear projection, and LCD.

5. The apparatus according to claim 1, wherein said shutter plate comprises a Liquid Crystal panel having a display area divided into optically active columns.

6. The apparatus according to claim 5, wherein said Liquid Crystal Panel is a PI-Cell type liquid crystal.

7. The apparatus according to claim 5, wherein said Liquid Crystal is a fast twisted nematic type liquid crystal.

8. The apparatus according to claim 5, wherein said Liquid Crystal is addressed by at least one of TFT, TFD and a passive bus system.

9. The apparatus according to claim 1, wherein said shutter plate is capable of alternating between optical states at at least 50 times per second.

10. The apparatus according to claim 1, wherein said shutter plate includes a switch for switching between 2D and 3D modes of operation.

11. The apparatus according to claim 1, wherein said shutter plate further comprises a control panel having at least one control button for controlling the positioning of a viewing sweet spot for a particular user.

12. The apparatus according to claim 1, wherein said shutter plate further comprises an outer frame, said apparatus further comprising an alignment system integrated into said outer frame and adapted for aligning a user's eyes for stereoscopic display of graphic data.

13. The apparatus according to claim 12, wherein said alignment system comprises:
a pair of spaced indents in said outer frame; and
a light source disposed in each of said indents, wherein said indents and said light source are spaced from each other a predetermined amount substantially equivalent to a distance between a user's left and right eyes.

14. The apparatus according to claim 2, wherein said connection means comprises an adapter frame having means for connecting to a front surface of the display monitor on one side and means for connecting to said shutter plate on an opposing side.

15. The apparatus according to claim 14, wherein said adapter frame has a predetermined depth corresponding to a predetermined gap distance between said shutter plate and the display monitor.

16. The apparatus according to claim 2, wherein said connection means comprises at least one strap connected to an outer frame of said shutter plate and adapted to adhere to the display monitor to secure said shutter plate against the display monitor.

17. The apparatus according to claim 16, wherein said at least one strap further comprises a hook and loop fastener and said display monitor includes corresponding hook and loop fasteners for receiving and securing said strap against said display monitor.

18. The apparatus according to claim 2, wherein said connection means comprises clips extending from an outer frame of said shutter plate, said clips adapted to engage the display monitor and secure said shutter plate there to.

19. The apparatus according to claim 18, wherein said clips engage a seam in the edge of the display monitor.

20. The apparatus according to claim 1, wherein said interface device comprises a dongle connecting the computer to the display device and the shutter plate.

21. The apparatus according to claim 20, wherein said dongle performs column multiplexing operations for setting positioning of a stereoscopic sweet spot for viewing by the user.

22. The apparatus according to claim 20, wherein said dongle further comprises a control panel for enabling software driver control.

23. A method for retrofitting a 2D display monitor connected to a computer for 3D display of images comprising:
providing and connecting a shutter plate to the front of the 2D display monitor;
providing and connecting the computer, the 2D display and the shutter plate to an interface device;
controlling the interface device to cyclically control said shutter plate to selectively cycle through optically active columns in said shutter plate in response to graphic information supplied to said interface device via the computer.
